(19) United States
(12) Patent Application Publication
(10) Pub. No.: US 2015/0229967 A1
(43) Pub. Date: Aug. 13, 2015

(54) INTER-LAYER VIDEO CODING METHOD AND DEVICE FOR PREDICTIVE INFORMATION BASED ON TREE STRUCTURE CODING UNIT, AND INTER-LAYER VIDEO DECODING METHOD AND DEVICE FOR PREDICTIVE INFORMATIONBASED ON TREE STRUCTURE CODING UNIT

(71) Applicant: SAMSUNG ELECTRONICS CO., LTD., Suwon-si (KR)

(72) Inventor: Tammy Lee, Seoul (KR)

(73) Assignee: SAMSUNG ELECTRONICS CO., LTD., Suwon-si (KR)

(21) Appl. No.: 14/423,282

(22) PCT Filed: Aug. 21, 2013
(86) PCT No.: PCT/KR2013/007489

§ 371 Date: Feb. 23, 2015

Related U.S. Application Data
(60) Provisional application No. 61/691,410, filed on Aug. 21, 2012.

(51) Int. Cl. H04N 19/597; H04N 19/159; H04N 19/176; H04N 19/139; H04N 19/513; H04N 19/105

(52) U.S. Cl. CPC H04N 19/597; H04N 19/521; H04N 19/105; H04N 19/176; H04N 19/139; H04N 19/159

(57) ABSTRACT

Provided are a method and apparatus for performing inter-layer prediction in a scalable video encoding and decoding system.

An inter-layer video encoding method according to one or more exemplary embodiments includes generating prediction information including a motion vector, a prediction direction, and a reference index, and residue information by performing inter-prediction on blocks of a base layer image; determining a base layer reference block that is from among the blocks of the base layer image and corresponds to a position of a current block from among blocks of an enhancement layer image; determining prediction information of the current block by using prediction information of the base layer reference block; performing inter-prediction on the current block by using the determined prediction information; and generating a slice header including information indicating motion vector prediction is possible between the base layer image and the enhancement layer image.

### CROSS-REFERENCE TO RELATED APPLICATIONS

This application is a National Stage of International Application No. PCT/KR2013/007489 filed Aug. 21, 2013, claiming priority based on U.S. Provisional Application No. 61/691,410 filed on Aug. 21, 2012, the contents of which are incorporated herein by reference in their entirety.

### BACKGROUND

1. Field

Exemplary embodiments relate to encoding and decoding a scalable video.

2. Related Art

As hardware for reproducing and storing high resolution or high quality video content is being developed and supplied, the need for a video codec that effectively encodes or decodes high resolution or high quality video content is increasing. According to a video codec of the related art, a video is encoded according to a limited encoding method based on a macroblock having a predetermined size.

Image data of a spatial domain is transformed into coefficients of a frequency domain via frequency transformation. According to a video codec, an image is split into blocks of a predetermined size, discrete cosine transformation (DCT) is performed on each block, and frequency coefficients are encoded in block units, for rapid calculation of frequency transformation. Compared with image data of a spatial domain, coefficients of a frequency domain are easily compressed. In particular, since an image pixel value of a spatial domain is expressed according to a prediction error via inter prediction or intra prediction of a video codec, when frequency transformation is performed on the prediction error, a large amount of data may be transformed to 0. Thus, by using a video codec, an amount of data may be reduced by replacing data that is consecutively and repeatedly generated with small-sized data.

With the demand for video captured with various image qualities or captured at multiple views, a transmission amount of video data that corresponds to the number of image quality levels or the number of views can be a problem. Thus, much effort is being made to efficiently encode and decode a multiview video and to decrease a transmission data amount.

### SUMMARY

Exemplary embodiments provide a method and apparatus for prediction encoding prediction information of an enhancement layer image by using prediction information of a base layer image in a scalable video encoding structure. Exemplary embodiments also provide a method and apparatus for prediction decoding the prediction information of the enhancement layer image by using the prediction information of the base layer image in a scalable video decoding structure.

According to one or more exemplary embodiments, there is provided an inter-layer video encoding method including operations of performing inter-prediction on blocks of a base layer image, and generating prediction information including a motion vector, a prediction direction, and a reference index, and residue information; determining a base layer candidate block that is from among the blocks of the base layer image and corresponds to a position of a current block from among blocks of an enhancement layer image, and determining prediction information of the current block by using prediction information of a reference block that is determined from among candidate blocks including the base layer candidate block; performing inter-prediction on the current block by using the determined prediction information, and generating residue information of the current block; and generating a slice header including information indicating motion vector prediction is possible between the base layer image and the enhancement layer image.

According to an aspect of an exemplary embodiment, there is provided an inter-layer video encoding method including operations of performing inter-prediction on blocks of a base layer image, and generating prediction information including a motion vector, a prediction direction, and a reference index, and residue information; determining a base layer candidate block that is from among the blocks of the base layer image and corresponds to a position of a current block from among blocks of an enhancement layer image, and determining prediction information of the current block by using prediction information of a reference block that is determined from among candidate blocks including the base layer candidate block; performing inter-prediction on the current block by using the determined prediction information, and generating residue information of the current block; and generating a slice header including information indicating motion vector prediction is possible between the base layer image and the enhancement layer image.

The operation of determining the prediction information may include operations of converting coordinates of the position of the current block in the enhancement layer image into coordinates in the base layer image, based on a size ratio of the base layer image to the enhancement layer image, reducing and restoring the coordinates through a bit-shift operation, and thus, compressing the coordinates; and determining, by using the compressed coordinates, a position of the base layer candidate block that corresponds to the current block.

The operation of determining the prediction information may include operations of scaling a motion vector of the base layer candidate block, based on a size ratio of the base layer image to the enhancement layer image; and determining a motion vector of the current block by using the scaled motion vector.

The operation of determining the prediction information may include operations of adding the base layer candidate block to a candidate list including at least one selected from a spatial candidate block of the enhancement layer image and a temporal candidate block of another enhancement layer image; comparing results of prediction that was performed on the prediction information of the current block by using a plurality of pieces of prediction information of candidate blocks included in the candidate list, and determining the reference block of the current block; and determining the prediction information of the current block by using the prediction information of the reference block, wherein a motion vector of the base layer candidate block is scaled based on a size ratio of the base layer image to the enhancement layer image, and the scaled motion vector is used in predicting the prediction information of the current block.

If a prediction mode of the prediction information of the current block is a merge mode, the operation of determining the prediction information may include an operation of determining the prediction information of the current block by using the motion vector, the prediction direction, and the reference index of the prediction information of the reference block, and the generating of the residue information may include an operation of generating a candidate list index indicating the reference block that is determined from the candidate list.

If a prediction mode of the prediction information of the current block is not a merge mode, the operation of determining the prediction information may include an operation of determining a motion vector, a prediction direction, and a reference index of the current block by using the motion vector, the prediction direction, and the reference index of the prediction information of the reference block, and the generating of the residue information may include an operation of generating a difference motion vector between a motion vector of the base layer block and the motion vector of the reference block, and a candidate list index indicating the reference block that is determined from the candidate list.

According to an aspect of another exemplary embodiment, there is provided an inter-layer video decoding method including operations of obtaining, from a base layer stream, prediction information including a motion vector, a prediction direction, and a reference index, and residue information of blocks of a base layer image; obtaining, from a slice header of an enhancement layer stream, information indicating that motion vector prediction is possible between the base layer image and an enhancement layer image; determining a base layer candidate block that is from among the blocks of the base layer image and corresponds to a position of a current block from among blocks of the enhancement layer image, and determining prediction information of the current block by using prediction information of a reference block that is determined from among candidate blocks including the base layer candidate block; and performing motion compensation on the current block by using the determined prediction information and residue information of the current block that is obtained from the enhancement layer stream, and thus, restoring the current block.

The operation of determining the prediction information may include operations of converting coordinates of the position of the current block in the enhancement layer image into coordinates in the base layer image, based on a size ratio of the base layer image to the enhancement layer image, reducing and restoring the coordinates through a bit-shift operation, and thus, compressing the coordinates; and determining, by using the compressed coordinates, a position of the base layer candidate block that corresponds to the current block.

The operation of determining the prediction information may include operations of scaling a motion vector of the base layer candidate block, based on a size ratio of the base layer image to the enhancement layer image; and determining a motion vector of the current block by using the scaled motion vector.

The operation of determining the prediction information may include operations of adding the base layer candidate block to a candidate list including candidate blocks including at least one selected from a spatial candidate block of the enhancement layer image and a temporal candidate block of another enhancement layer image; determining the reference block of the current block from the candidate list by using a candidate list index obtained from the enhancement layer stream; and determining the prediction information of the current block by using the prediction information of the reference block, wherein a motion vector of the base layer candidate block is scaled based on a size ratio of the base layer image to the enhancement layer image, and the scaled motion vector is used in predicting the prediction information of the current block.

The inter-layer video decoding method may further include, if a prediction mode of the prediction information of the current block is a merge mode, an operation of obtaining the residue information and the candidate list index from the enhancement layer stream, and wherein the operation of determining the prediction information may include an operation of determining the prediction information of the current block by using the motion vector, the prediction direction, and the reference index of the prediction information of the reference block.

The inter-layer video decoding method may further include, if a prediction mode of the prediction information of the current block is not a merge mode, an operation of obtaining the residue information, the candidate list index, and a difference motion vector from the enhancement layer stream, and wherein the operation of determining the prediction information may include an operation of determining a motion vector of the current block by combining the motion vector with the difference motion vector of the prediction information of the reference block.

According to an aspect of another exemplary embodiment, there is provided an inter-layer video encoding apparatus including a base layer encoder for performing inter-prediction on blocks of a base layer image, and generating prediction information including a motion vector, a prediction direction, and a reference index, and residue information; and an enhancement layer encoder for determining a base layer candidate block that is from among the blocks of the base layer image and corresponds to a position of a current block from among blocks of an enhancement layer image, for determining prediction information of the current block by using prediction information of the base layer candidate block, and for generating residue information of the current block by performing inter-prediction on the current block by using the determined prediction information, and wherein the enhancement layer encoder generates a slice header including information indicating motion vector prediction is possible between the base layer image and the enhancement layer image.

According to an aspect of another exemplary embodiment, there is provided an inter-layer video decoding apparatus including a base layer decoder for obtaining, from a base layer stream, prediction information including a motion vector, a prediction direction, and a reference index, and residue information of blocks of a base layer image; and an enhancement layer decoder for determining a base layer candidate block that is from among the blocks of the base layer image and corresponds to a position of a current block from among blocks of an enhancement layer image, for determining prediction information of the current block by using prediction information of the base layer candidate block, and for performing motion compensation on the current block by using the determined prediction information and residue information of the current block that is obtained from an enhancement layer stream, and thus, restoring the current block, and wherein the enhancement layer decoder obtains, from a slice header of the enhancement layer stream, information indicating that motion vector prediction is possible between the base layer image and the enhancement layer image.

According to an aspect of another exemplary embodiment, there is provided a computer-readable recording medium having recorded thereon a program for executing the inter-layer video encoding method. According to an aspect of another exemplary embodiment, there is provided a computer-readable recording medium having recorded thereon a program for executing the inter-layer video decoding method.

According to an aspect of another exemplary embodiment, there is provided an inter-layer video encoding method includes operations of generating intra-index information of each of blocks of a base layer image by performing intra-prediction on the blocks; determining a base layer block that is from among the blocks of the base layer image and corresponds to a position of a current block from among blocks of an enhancement layer image, and determining an intra-index of the current block based on uniformity between intra-indexes of two or more blocks that are spatially adjacent to the current block and an intra-index of the base layer block; and performing intra-prediction on the current block by using the determined intra-index.

If a left neighboring block and an upper neighboring block of the current block, and the base layer block have a common intra-index, and the common intra-index is a first intra-index or a second intra-index, the operation of determining the intra-index may include an operation of fixedly setting three candidate intra-indexes of the current block as the first intra-index, the second intra-index, and a third intra-index, respectively.

If the left neighboring block and the upper neighboring block of the current block, and the base layer candidate block have a common intra-index, and the common intra-index is neither the first intra-index nor the second intra-index, the operation of determining the intra-index may include an operation of setting the three candidate intra-indexes of the current block as the common intra-index, and two intra-indexes that are adjacent to the common intra-index, respectively.

If two blocks of the left neighboring block and the upper neighboring block of the current block, and the base layer candidate block have a common intra-index, the operation of determining the intra-index may include an operation of setting the three candidate intra-indexes of the current block as the common intra-index of the two blocks, an intra-index of the other block of the two blocks, and the first intra-index.

If intra-indexes of the left neighboring block and the upper neighboring block of the current block, and the base layer candidate block are different from each other, the operation of determining the intra-index may include an operation of setting the three candidate intra-indexes of the current block as an intra-index of the left neighboring block, an intra-index of the upper neighboring block, and an intra-index of the base layer candidate block, respectively.

According to an aspect of another exemplary embodiment, there is provided an inter-layer video decoding method includes operations of obtaining intra-indexes of blocks of a base layer image from a base layer stream; determining a base layer block that is from among the blocks of the base layer image and corresponds to a position of a current block from among blocks of an enhancement layer image, and determining an intra-index of the current block based on uniformity between intra-indexes of two or more blocks that are spatially adjacent to the current block and an intra-index of the base layer block; and performing intra-prediction on the current block by using the determined intra-index, and restoring the current block.

If a left neighboring block and an upper neighboring block of the current block, and the base layer block have a common intra-index, and the common intra-index is a first intra-index or a second intra-index, the operation of determining the intra-index may include operations of fixedly setting three candidate intra-indexes of the current block as the first intra-index, the second intra-index, and a third intra-index, respectively; and determining an intra-index that is from among the three candidate intra-indexes and is indicated by a candidate list index for the current block obtained from the enhancement layer stream.

If the left neighboring block and the upper neighboring block of the current block, and the base layer candidate block have a common intra-index, and the common intra-index is neither the first intra-index nor the second intra-index, the operation of determining the intra-index may include an operation of setting the three candidate intra-indexes of the current block as the common intra-index, and two intra-indexes that are adjacent to the common intra-index, respectively.

If two blocks of the left neighboring block and the upper neighboring block of the current block, and the base layer candidate block have a common intra-index, the operation of determining the intra-index may include an operation of setting the three candidate intra-indexes of the current block as the common intra-index of the two blocks, an intra-index of the other block of the two blocks, and the first intra-index.

If intra-indexes of the left neighboring block and the upper neighboring block of the current block, and the base layer candidate block are different from each other, the operation of determining the intra-index may include an operation of setting the three candidate intra-indexes of the current block as an intra-index of the left neighboring block, an intra-index of the upper neighboring block, and an intra-index of the base layer candidate block, respectively.

According to an aspect of another exemplary embodiment, there is provided an inter-layer video encoding apparatus includes a base layer encoder for generating intra-prediction mode information for each of blocks of a base layer image by performing intra-prediction on the blocks; and an enhancement layer encoder for determining a base layer block that is from among the blocks of the base layer image and corresponds to a position of a current block from among blocks of an enhancement layer image, and determining an intra-index of the current block based on uniformity between intra-indexes of two or more blocks that are spatially adjacent to the current block and an intra-index of the base layer block, and for performing intra-prediction on the current block by using the determined intra-index.

According to an aspect of another exemplary embodiment, there is provided an inter-layer video decoding apparatus includes a base layer decoder for obtaining an intra-prediction mode of blocks of a base layer image from a base layer stream; and an enhancement layer decoder for determining a base layer block that is from among the blocks of the base layer image and corresponds to a position of a current block from among blocks of an enhancement layer image, and determining an intra-index of the current block based on uniformity between intra-indexes of two or more blocks that are spatially adjacent to the current block and an intra-index of the base layer block, and for performing intra-prediction on the current block by using the determined intra-index, and restoring the current block.

According to an aspect of another exemplary embodiment, there is provided a computer-readable recording medium having recorded thereon a program for executing the inter-layer video encoding method. According to an aspect of another exemplary embodiment, there is provided a computer-readable recording medium having recorded thereon a program for executing the inter-layer video decoding method.

According to an aspect of another exemplary embodiment, there is provided an inter-layer video encoding method includes operations of performing prediction encoding on blocks of a base layer image; determining a base layer block that is from among the blocks of the base layer image and corresponds to a position of a current block from among blocks of an enhancement layer image; determining a reference block for the current block from a motion candidate list including the base layer block and one or more candidate blocks that are from among the blocks of the enhancement layer image and are adjacent to the current block, and determining prediction information of the current block based on prediction information of the reference block; and performing prediction encoding on the current block by using the determined prediction information.

According to an aspect of another exemplary embodiment, there is provided an inter-layer video decoding method includes operations of obtaining prediction information about blocks of a base layer image from a base layer stream; determining a base layer block that is from among the blocks of the base layer image and corresponds to a position of a current block from among blocks of an enhancement layer image; determining a reference block for the current block from a motion candidate list including the base layer block and one or more candidate blocks that are from among the blocks of the enhancement layer image and are adjacent to the current block, and determining prediction information of the current block based on prediction information of the reference block; and performing decoding on the current block by using the determined prediction information, and restoring the current block.

According to an inter-layer video encoding method and apparatus therefor using prediction information, and an inter-layer video decoding method and apparatus therefor using prediction information according to one or more exemplary embodiments, a video may be encoded and decoded based on coding units of a tree structure, a prediction unit, and a transformation unit, and for prediction encoding and decoding operations, not only a residue component of the prediction unit but also prediction information of the prediction unit may be determined based on prediction information of a reference block. By using not only prediction information of a spatial candidate block or a temporal candidate block of a current prediction unit in a same layer image but also by using prediction information of a reference layer prediction unit disposed at a position of another layer image that corresponds to a position of the current prediction unit, prediction information of the current prediction unit may be determined.

### BRIEF DESCRIPTION OF THE DRAWINGS

FIG. 1 is a block diagram of a video encoding apparatus based on coding units of a tree structure, according to an exemplary embodiment.

FIG. 2 is a block diagram of a video decoding apparatus based on coding units of a tree structure, according to an exemplary embodiment.

FIG. 3 is a diagram for describing a concept of coding units according to an exemplary embodiment.

FIG. 4 is a block diagram of an image encoder based on coding units, according to an exemplary embodiment.

FIG. 5 is a block diagram of an image decoder based on coding units, according to an exemplary embodiment.

FIG. 6 is a diagram illustrating deeper coding units according to depths, and partitions, according to an exemplary embodiment.

FIG. 7 is a diagram for describing a relationship between a coding unit and transformation units, according to an exemplary embodiment.

FIG. 8 illustrates a plurality of pieces of encoding information according to depths, according to an exemplary embodiment.

FIG. 9 is a diagram of deeper coding units according to depths, according to an exemplary embodiment.

FIGS. 10, 11, and 12 are diagrams for describing a relationship between coding units, prediction units, and transformation units, according to an exemplary embodiment.

FIG. 13 is a diagram for describing a relationship between a coding unit, a prediction unit, and a transformation unit, according to encoding mode information of Table 1.

FIG. 14 is a block diagram of an inter-layer video encoding apparatus for prediction information, according to one or more exemplary embodiments.

FIG. 15 is a block diagram of an inter-layer video decoding apparatus, for prediction information, according to one or more exemplary embodiments.

FIG. 16 is a block diagram of an inter-layer video encoding system, according to one or more exemplary embodiments.

FIG. 17 illustrates a mapping relation between a base layer and an enhancement layer, according to one or more exemplary embodiments.

FIG. 18 illustrates positions of spatial candidate blocks for merging a plurality of pieces of prediction information, according to an exemplary embodiment.

FIG. 19 illustrates positions of temporal candidate blocks and a scaling method for merging a plurality of pieces of prediction information, according to an exemplary embodiment.

FIG. 20 illustrates positions of spatial prediction candidates and a scaling method for adaptively predicting prediction information, according to an exemplary embodiment.

FIG. 21 is a flowchart of a method of performing inter-layer video encoding by using prediction information, according to one or more exemplary embodiments.

FIG. 22 is a flowchart of a method of performing inter-layer video decoding by using prediction information, according to one or more exemplary embodiments.

FIG. 23 is a flowchart of an inter-layer video encoding method performed in an inter-mode, according to an exemplary embodiment.

FIG. 24 is a flowchart of an inter-layer video decoding method performed in an inter-mode, according to an exemplary embodiment.

FIG. 25 is a flowchart of an inter-layer video encoding method performed in an intra-mode, according to another exemplary embodiment.

FIG. 26 is a flowchart of an inter-layer video decoding method performed in an intra-mode, according to another exemplary embodiment.

FIG. 27 is a diagram of a physical structure of a disc in which a program is stored, according to an exemplary embodiment.

FIG. 28 is a diagram of a disc drive for recording and reading a program by using the disc.

FIG. 29 is a diagram of an overall structure of a content supply system for providing a content distribution service.

FIGS. 30 and 31 illustrate external and internal structures of a mobile phone to which a video encoding method and a video decoding method are applied, according to an exemplary embodiment.

FIG. 32 illustrates a digital broadcasting system employing a communication system, according to an exemplary embodiment.

FIG. 33 is a diagram illustrating a network structure of a cloud computing system using a video encoding apparatus and a video decoding apparatus, according to an exemplary embodiment.

### DETAILED DESCRIPTION OF EXEMPLARY EMBODIMENTS

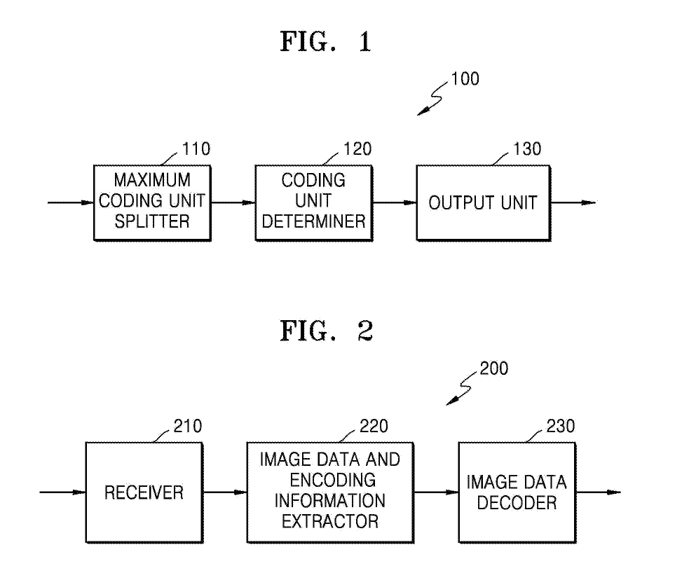

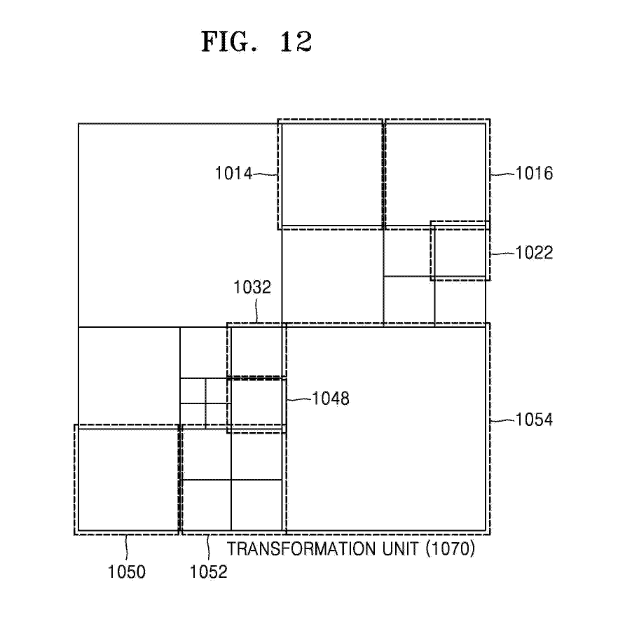

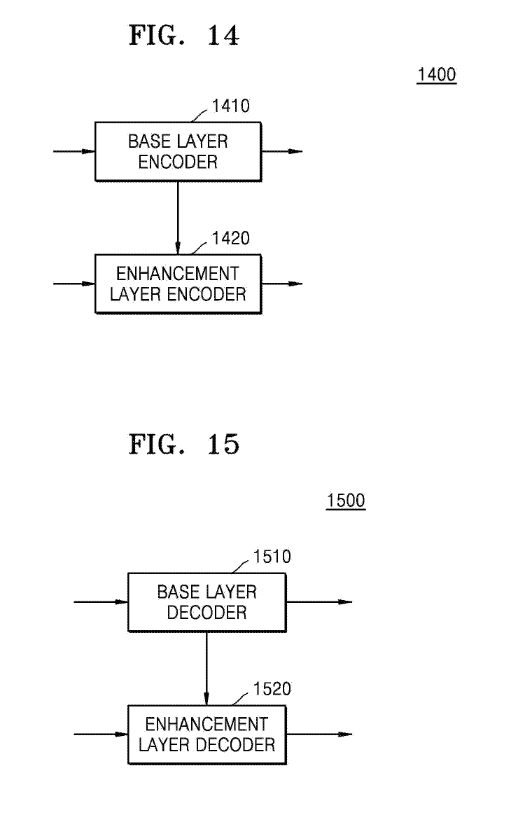

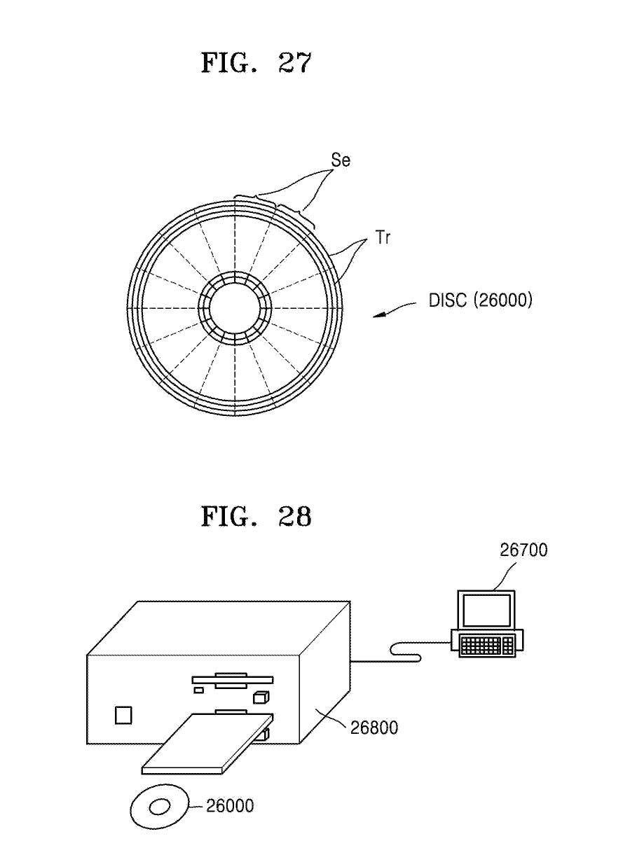

Hereinafter, a video encoding technique and a video decoding technique based on coding units of a tree structure, according to exemplary embodiments, will be described with reference to FIGS. 1 through 13. Also, an inter-layer video encoding technique and an inter-layer video decoding technique based on coding units of a tree structure, according to exemplary embodiments, will be described with reference to FIGS. 14 through 26. Also, various exemplary embodiments to which an inter-layer video encoding method, an inter-layer video decoding method, a video encoding method, and a video decoding method may be applied are provided with reference to FIGS. 27 through 33. Hereinafter, an ‘image’ may indicate a still image or a moving image of a video, or a video itself.

First, the video encoding technique and the video decoding technique based on coding units of a tree structure will be described with reference to FIGS. 1 through 13.

FIG. 1 is a block diagram of a video encoding apparatus based on coding units of a tree structure 100, according to an exemplary embodiment.

The video encoding apparatus involving video prediction based on coding units of the tree structure 100 includes a maximum coding unit splitter 110, a coding unit determiner 120, and an output unit 130 (e.g., an output, etc.). Hereinafter, for convenience of description, the video encoding apparatus involving video prediction based on coding units of the tree structure 100 is referred as ‘video encoding apparatus 100’.

The maximum coding unit splitter 110 may split a current picture based on a maximum coding unit that is a coding unit having a maximum size for a current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes the number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to the same depth in one maximum coding unit, it is determined whether to split each of the coding units corresponding to the same depth to a lower depth by measuring an encoding error of the image data of the each coding unit, separately. Accordingly, even when image data is included in one maximum coding unit, the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of splitting times from a maximum coding unit to a minimum coding unit. A first maximum depth according to an exemplary embodiment may denote the total number of splitting times from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3, and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit.

Since the number of deeper coding units increases whenever the maximum coding unit is split according to depths, encoding, including the prediction encoding and the transformation, is performed on all of the deeper coding units generated as the depth increases. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one selected from a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one selected from an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residue data in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

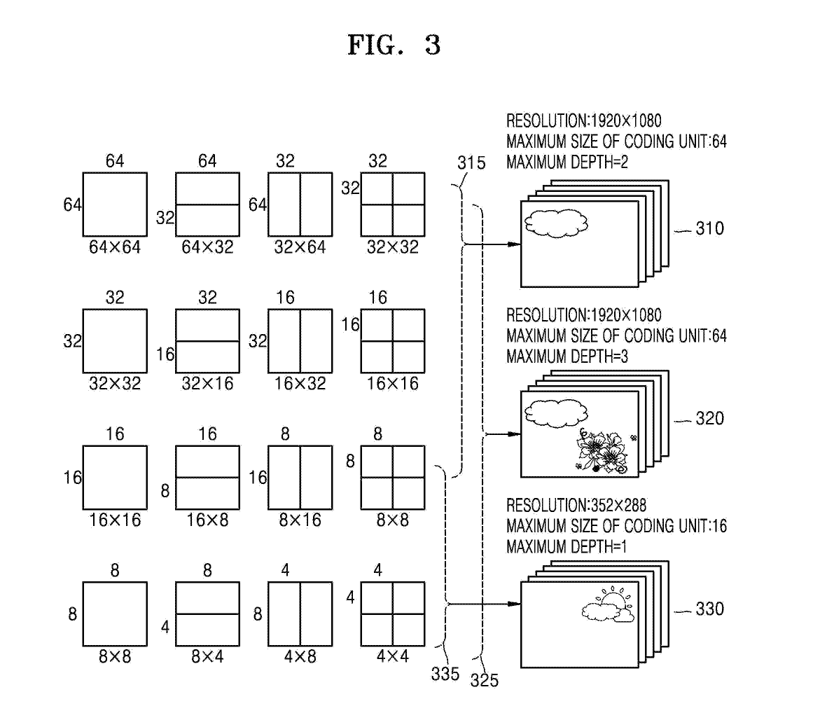

Coding units according to a tree structure in a maximum coding unit and methods of determining a prediction unit/partition, and a transformation unit, according to exemplary embodiments, will be described in detail later with reference to FIGS. 3 through 13.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residue data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a square data unit obtained by splitting the minimum coding unit constituting the lowermost depth by 4. Alternatively, the minimum unit according to an exemplary embodiment may be a maximum square data unit that may be included in all of the coding units, prediction units, partition units, and transformation units included in the maximum coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 130 may encode and output reference information, prediction information, and slice type information that are related to prediction described above with reference to FIGS. 1 through 6.

According to the an exemplary embodiment for the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having a high resolution or a large data amount is encoded in a related art macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

FIG. 2 is a block diagram of a video decoding apparatus based on coding units of a tree structure 200, according to an exemplary embodiment.

The video decoding apparatus involving video prediction based on coding units of the tree structure 200 includes a receiver 210, an image data and encoding information extractor 220, and an image data decoder 230. Hereinafter, for convenience of description, the video decoding apparatus involving video prediction based on coding units of the tree structure 200 is referred as ‘video decoding apparatus 200’.

Definitions of various terms, such as a coding unit, a depth, a prediction unit, a transformation unit, and information about various encoding modes, for decoding operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. If information about a coded depth and encoding mode of a corresponding maximum coding unit is recorded according to predetermined data units, the predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read information about a transformation unit according to a tree structure for each coding unit so as to perform inverse transformation based on transformation units for each coding unit, for inverse transformation for each maximum coding unit. Via the inverse transformation, a pixel value of a spatial domain of the coding unit may be restored.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data in the current maximum coding unit by using the information about the partition type of the prediction unit, the prediction mode, and the size of the transformation unit for each coding unit corresponding to the coded depth.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

Thus, the video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded.

Accordingly, even if an image has high resolution or has an excessively large data amount, the image may be efficiently decoded and restored by using a size of a coding unit and an encoding mode, which are adaptively determined according to characteristics of the image, by using information about an optimum encoding mode received from an encoder.

FIG. 3 is a diagram for describing a concept of coding units according to an exemplary embodiment.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoder.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are increased to two layers by splitting the maximum coding unit twice. On the other hand, since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be precisely expressed.

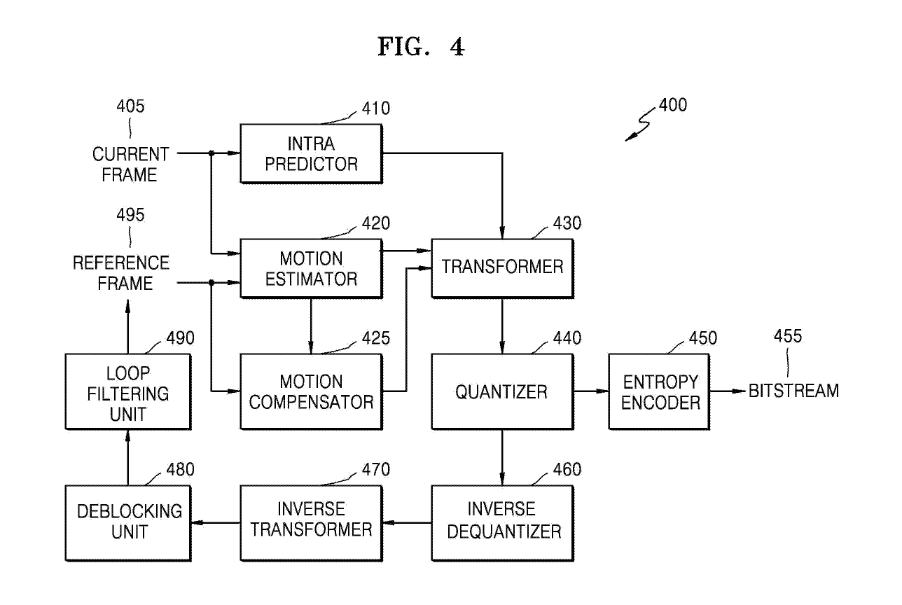

FIG. 4 is a block diagram of an image encoder 400 based on coding units, according to an exemplary embodiment.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 respectively perform inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 (e.g., a deblocker, etc.) and an offset adjusting unit 490 (e.g., a loop filtering unit, a loop filterer, etc.). The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the offset adjusting unit 490 perform operations based on each coding unit among coding units having a tree structure while the maximum depth of each maximum coding unit is considered.

Specifically, the intra predictor 410, the motion estimator 420, and the motion compensator 425 determine partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

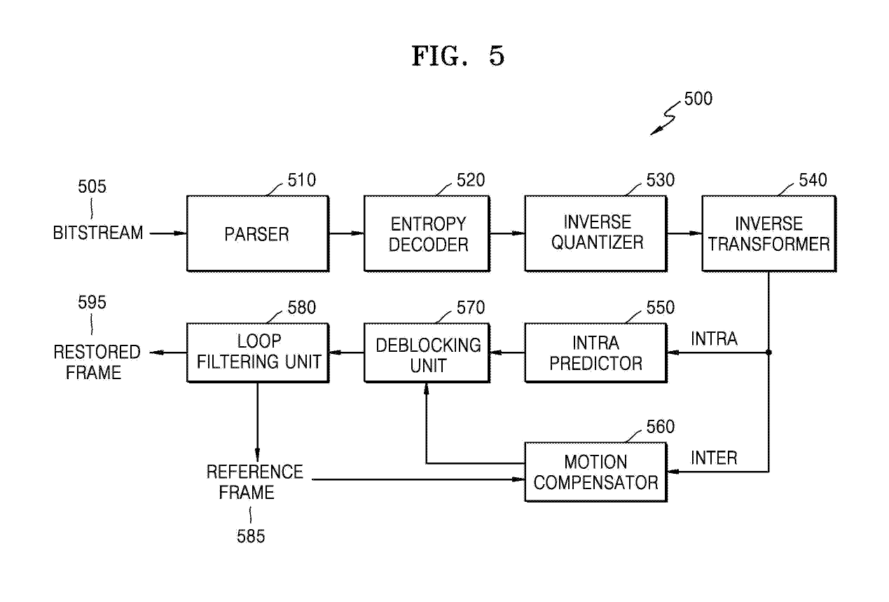

FIG. 5 is a block diagram of an image decoder 500 based on coding units, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 (e.g., a deblocker, etc.) and an offset adjusting unit 580 (e.g., a loop filtering unit, a loop filterer, etc.). Also, the image data that is post-processed through the deblocking unit 570 and the offset adjusting unit 580 may be output as the reference frame 585.

In order to decode the image data in the image data decoder 230 of the video decoding apparatus 200, the image decoder 500 may perform operations that are performed after the parser 510.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the offset adjusting unit 580 perform operations based on coding units having a tree structure for each maximum coding unit.

In particular, the intra predictor 550 and the motion compensator 560 have to determine partitions and a prediction mode for each of the coding units having a tree structure, and the inverse transformer 540 have to determine a size of a transformation unit for each coding unit.

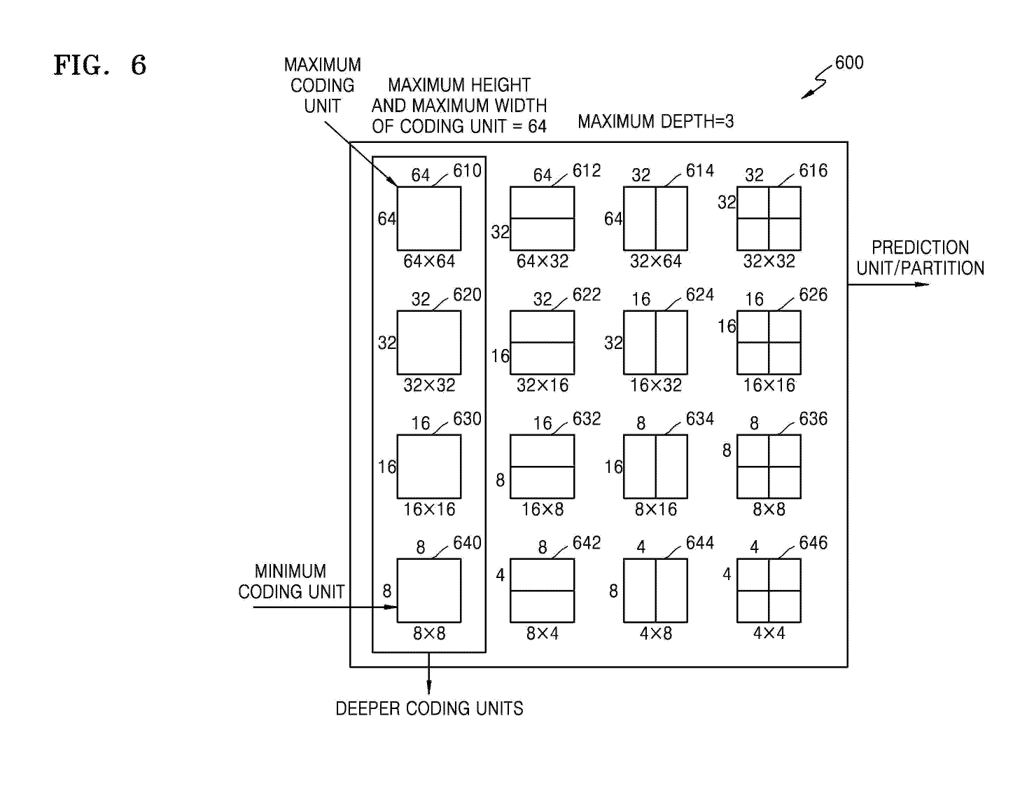

FIG. 6 is a diagram illustrating deeper coding units according to depths, and partitions, according to an exemplary embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 3. In this case, the maximum depth refers to a total number of times the coding unit is split from the maximum coding unit to the minimum coding unit. Since a depth increases along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having the size of 8×8 and the depth of 3 is a minimum coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoder 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

Lastly, the coding unit 640 having the size of 8×8 and the depth of 3 is a minimum coding unit having a lowermost depth.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error that is a representative encoding error may be selected for the current depth by performing encoding for each prediction unit in the coding units corresponding to the current depth, along the horizontal axis of the hierarchical structure 600. Alternatively, the minimum encoding error may be searched for by comparing representative encoding errors according to depths, by performing encoding for each depth as the depth increases along the vertical axis of the hierarchical structure 600. A depth and a partition having the minimum encoding error in the coding unit 610 may be selected as the coded depth and a partition type of the coding unit 610.

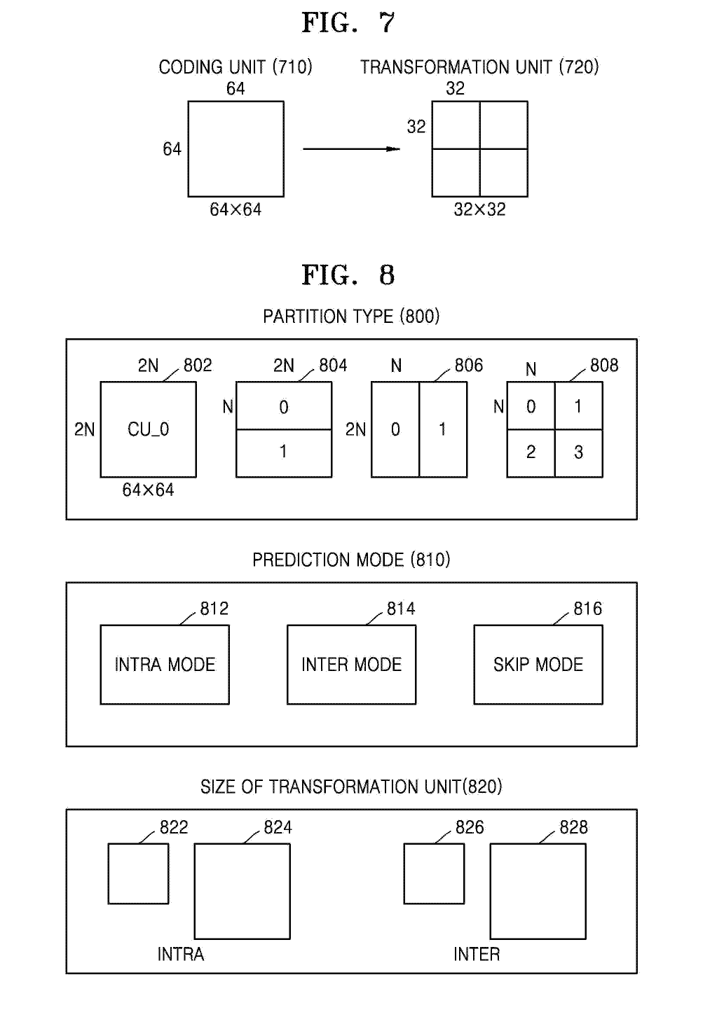

FIG. 7 is a diagram for describing a relationship between a coding unit 710 and transformation units 720, according to an exemplary embodiment.

The video encoding apparatus 100 or the video decoding apparatus 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or the video decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 8 illustrates a plurality of pieces of encoding information according to depths, according to an exemplary embodiment.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information about a partition type 800 indicates a type of partition of a coding unit. The information about a partition type may be information indicating at least one of a 2N×2N partition type 802, information indicating a 2N×N partition type 804, information indicating an N×2N partition type 806 and information indicating an N×N partition type 808.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

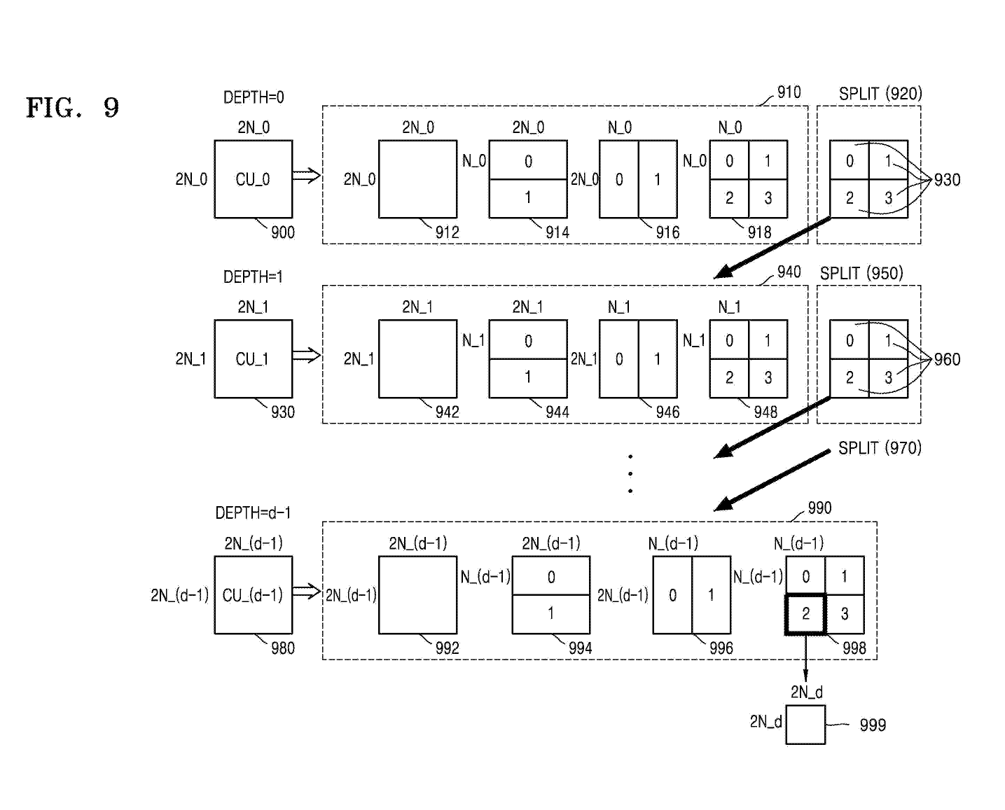

FIG. 9 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0 and N_{—}0×2N_{—}0, the prediction unit 910 may not be split into a lower depth.

If the encoding error is the smallest in the partition type 918 having the size of N_{—}0×N_{—}0, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1×N_{—}1, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 having the size of N_(d−1)×N_(d−1) has the minimum encoding error, since a maximum depth is d, a coding unit CU_(d−1) having a depth of d−1 is no longer split into a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d, split information for the minimum coding unit 980 is not set.

A data unit 999 may be a ‘minimum unit’ for the current maximum coding unit. A minimum unit according to an exemplary embodiment may be a square data unit obtained by splitting a minimum coding unit 980 having a lowermost coded depth by 4. By performing the encoding repeatedly, the video encoding apparatus 100 according to an exemplary embodiment may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 0, 1, . . . , d−1, d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 according to an exemplary embodiment may extract and use the information about the coded depth and the prediction unit of the coding unit 900 to decode the partition 912. The video decoding apparatus 200 according to an exemplary embodiment may determine a depth, in which split information is 0, as a coded depth by using split information according to depths, and use information about an encoding mode of the corresponding depth for decoding.

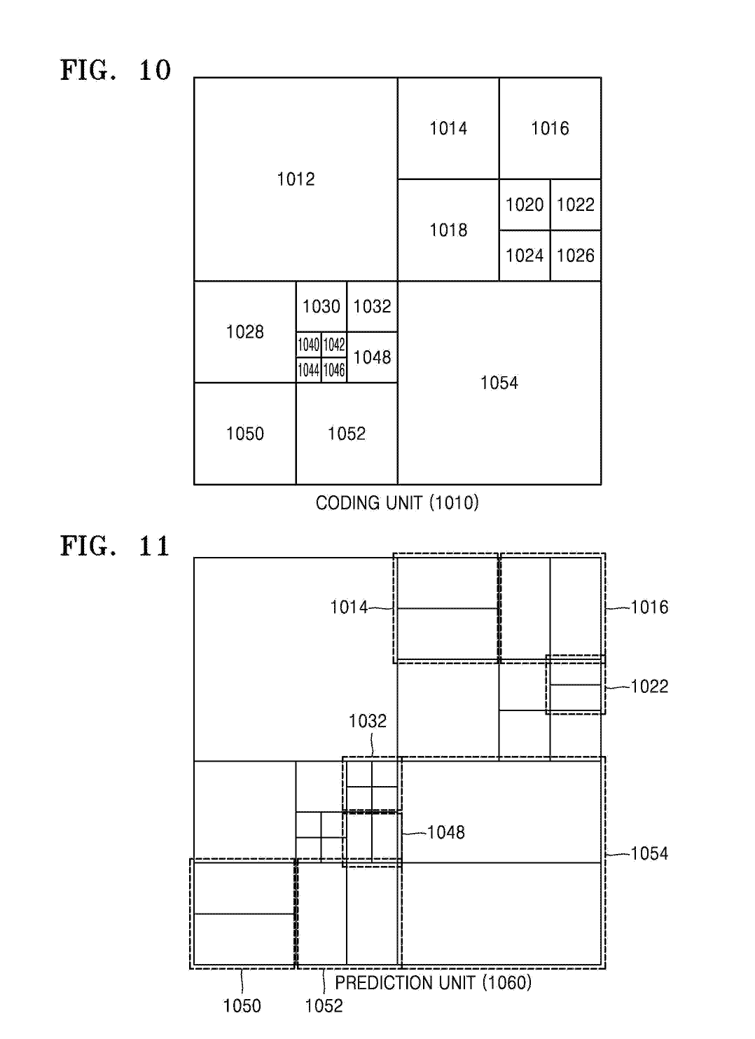

FIGS. 10, 11, and 12 are diagrams for describing a relationship between coding units 1010, prediction units 1060, and transformation units 1070, according to an exemplary embodiment.

The coding units 1010 are deeper coding units according to depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoders 1014, 1016, 1022, 1032, 1048, 1050, 1052, and 1054 are obtained by splitting the coding units in the encoders 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding apparatus 100 according to the exemplary embodiment and the video decoding apparatus 200 according to the exemplary embodiment may perform intra prediction/motion estimation/motion compensation/and transformation/inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to the exemplary embodiment and the video decoding apparatus 200 according to the exemplary embodiment.

TABLE 1

| Split Information 0 | | | | | Split |
|---|---|---|---|---|---|
| (Encoding on Coding Unit having Size of 2N × 2N and Current Depth of d) | | | | | Information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transformation | Transformation | Lower Depth |
| (Only | | | Unit | Unit | of d + 1 |
| 2N × N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 according to the exemplary embodiment may output the encoding information about the coding units having a tree structure, and the image data and encoding information extractor 220 of the video decoding apparatus 200 according to the exemplary embodiment may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure according to the exemplary embodiment may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

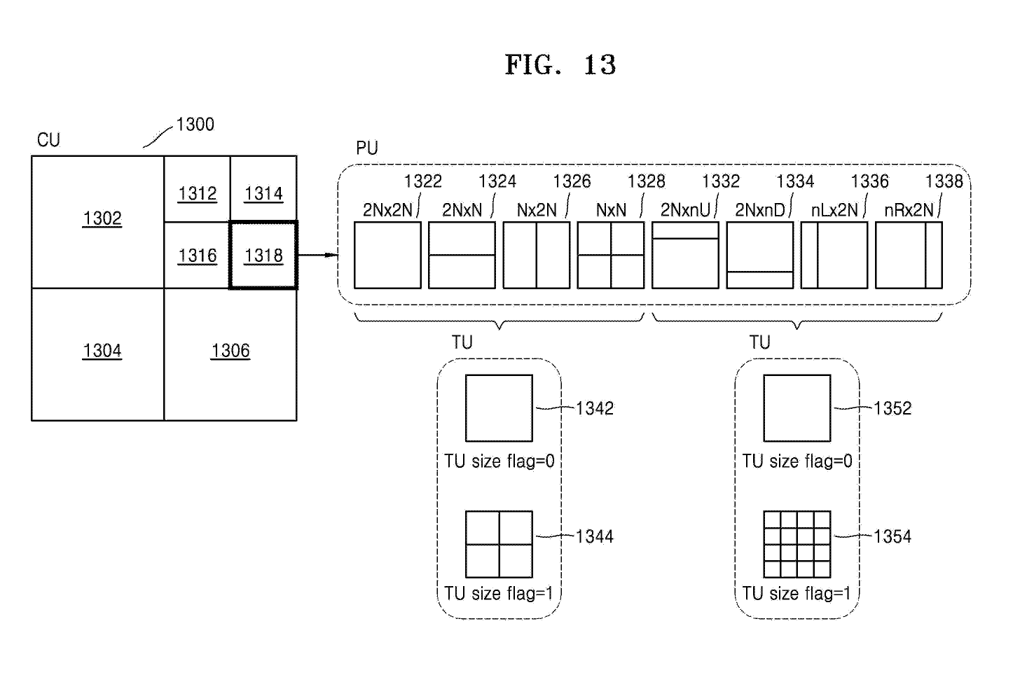

FIG. 13 is a diagram for describing a relationship between a coding unit, a prediction unit, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of partition types including 2N×2N 1322, 2N×N 1324, N×2N 1326, N×N 1328, 2N×nU 1332, 2N×nD 1334, nL×2N 1336, and nR×2N 1338.

Transformation unit split information (TU size flag) is a type of a transformation index. A size of a transformation unit corresponding to the transformation index may be changed according to a prediction unit type or partition type of the coding unit.

For example, when the information about the partition type is set to be one of symmetrical partition types 2N×2N 1322, 2N×N 1324, N×2N 1326, and N×N 1328, a transformation unit 1342 having a size of 2N×2N is set if the transformation unit split information is 0, and a transformation unit 1344 having a size of N×N is set if the transformation unit split information is 1.

When the information about the partition type is set to be one of asymmetrical partition types 2N×nU 1332, 2N×nD 1334, nL×2N 1336, and nR×2N 1338, a transformation unit 1352 having a size of 2N×2N is set if the transformation unit split information is 0, and a transformation unit 1354 having a size of N/2×N/2 is set if the transformation unit split information is 1.

As described above with reference to FIG. 13, the transformation unit split information (TU size flag) is a flag having a value or 0 or 1, but the transformation unit split information is not limited to a flag having 1 bit, and the transformation unit may be hierarchically split while the transformation unit split information increases from 0. The transformation unit split information may be an example of the transformation index.

In this case, the size of a transformation unit that has been actually used may be expressed by using the transformation unit split information according to the exemplary embodiment, together with a maximum size of the transformation unit and a minimum size of the transformation unit. The video encoding apparatus 100 according to the exemplary embodiment is capable of encoding maximum transformation unit size information, minimum transformation unit size information, and maximum transformation unit split information. The result of encoding the maximum transformation unit size information, the minimum transformation unit size information, and the maximum transformation unit split information may be inserted into an SPS. The video decoding apparatus 200 according to the exemplary embodiment may decode video by using the maximum transformation unit size information, the minimum transformation unit size information, and the maximum transformation unit split information.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizelndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the exemplary embodiments are not limited thereto.

The maximum coding unit that includes coding units of the tree structure described above with reference to FIGS. 1 through 13 may be variously referred to as a coding block tree, a block tree, a root block tree, a coding tree, a coding root, or a tree trunk.

Hereinafter, with reference to FIGS. 14 through 26, an inter-layer video encoding technique using prediction information and an inter-layer video decoding technique using the prediction information based on coding units of a tree structure will now be described.

FIG. 14 is a block diagram of an inter-layer video encoding apparatus 1400 for prediction information, according to one or more exemplary embodiments.

The inter-layer video encoding apparatus 1400 according to one or more exemplary embodiments includes a base layer encoder 1410, and an enhancement layer encoder 1420.

The inter-layer video encoding apparatus 1400 may encode different videos according to layers. Videos of the same content that have different resolutions or different frame speeds may be classified into layers, or videos of different contents may be classified into layers.

The base layer encoder 1410 may encode a base layer image from among multi-layered images.

The base layer encoder 1410 may encode the base layer image, based on the coding units of the tree structure described above with reference to FIGS. 1 through 13. The base layer encoder 1410 may split the base layer image into maximum coding units, may determine an encoding mode for the coding units of the tree structure in which a split is complete among coding units obtained by hierarchically splitting each of the maximum coding units, and may output encoded data.

The enhancement layer encoder 1420 may encode an enhancement layer image from among the multi-layered images.

The enhancement layer encoder 1420 may encode the enhancement layer image, based on the coding units of the tree structure described above with reference to FIGS. 1 through 13. The enhancement layer encoder 1420 may split the enhancement layer image into maximum coding units, may determine an encoding mode for tree-structure coding units of each of the maximum coding units, and may generate encoded data.

The enhancement layer encoder 1420 may encode the enhancement layer image by referring to at least one of a sample and the encoding mode of the base layer image. The enhancement layer encoder 1420 may refer to the encoding mode of a coding unit, a prediction unit, or a transformation unit of the base layer image, and thus, may determine the encoding mode of a coding unit, a prediction unit, or a transformation unit of the enhancement layer image.

The inter-layer video encoding apparatus 1400 may perform inter-layer video encoding on the multi-layered images. For example, the inter-layer video encoding apparatus 1400 may perform an inter-layer video encoding operation between the base layer image and a first enhancement layer image, an inter-layer video encoding operation between the base layer image and a second enhancement layer image, an inter-layer video encoding operation between the first enhancement layer image and the second enhancement layer image, or multi-level inter-layer video encoding operation among the base layer image, the first enhancement layer image, and the second enhancement layer image. Hereinafter, for convenience of description, an inter-layer video encoding operation between the base layer image and the enhancement layer image will be described. However, an operation of an exemplary embodiment is not limited to the inter-layer video encoding operation between the base layer image and the enhancement layer image.

The enhancement layer encoder 1420 may perform encoding on sub-blocks of tree-structure coding units of the enhancement layer image. The enhancement layer encoder 1420 may perform prediction on each of prediction units. Inter-prediction may be performed on a prediction unit of an inter-mode, and intra-prediction may be performed on a prediction unit of an intra-mode. The enhancement layer encoder 1420 may perform transformation and quantization on each of transformation units.

Also, the enhancement layer encoder 1420 may determine an inter-layer video encoding mode that is information indicating whether to refer to the encoding mode of the base layer image in order to encode the enhancement layer image. The enhancement layer encoder 1420 may predict, based on the inter-layer video encoding mode, the encoding mode of the enhancement layer image by using the encoding mode of the base layer image.

The enhancement layer encoder 1420 may encode the enhancement layer image by using the predicted encoding mode, and thus may generate the encoded data.

With reference to prediction information of the inter-prediction, the enhancement layer encoder 1420 may determine motion information of the enhancement layer image by using motion information of the base layer image. The prediction information according to the inter-prediction may include a partition type, a motion vector, a reference direction, and a reference index. In this case, the enhancement layer encoder 1420 may perform prediction on the enhancement layer image by using the determined prediction information, and thus may generate a difference component. The enhancement layer encoder 1420 may not output prediction information obtained based on prediction information of the base layer image but may output residue information.

The base layer encoder 1410 may output the encoding mode of the base layer image, and a quantized transform coefficient of the residue information. The base layer encoder 1410 may perform encoding on each of the maximum coding units, based on the coding units of the tree structure, and thus may output the encoded data.

Also, the enhancement layer encoder 1420 may output an inter-layer video encoding mode of the enhancement layer image. While the enhancement layer encoder 1420 performs encoding on each of the maximum coding units, based on the coding units of the tree structure, the enhancement layer encoder 1420 may exclude encoding information obtained from the base layer image and may output newly-generated encoding information.

The encoding information of the base layer image that is referable for the enhancement layer image may be at least one of a plurality of pieces of encoded information including an encoding mode, a prediction value, syntax, and a restoration value, or the like that are determined according to an encoding result.

The encoding mode according to an exemplary embodiment may include structure information of a coding unit, and prediction information of a prediction mode. The structure information of the coding unit may include a depth of a current coding unit, and depths and partition types of coding units that constitute the current coding unit. The prediction information of the intra-prediction may include a partition type and an intra-index of the intra-mode. The intra-index is information indicating positions or directions of samples that are referred to for the intra-prediction. As described above, the prediction information of the intra-prediction may include the partition type, the motion vector, the reference direction, and the reference index of the inter-mode. The prediction value according to an exemplary embodiment may indicate at least one of a quantized transform coefficient, a difference value between coefficients according to the inter-prediction, and residue data.

The enhancement layer encoder 1420 may determine the prediction information of the enhancement layer image by using the prediction information of the base layer image. The enhancement layer encoder 1420 may encode the enhancement layer image, based on the prediction information of the enhancement layer image that is predicted from the base layer image.

The enhancement layer encoder 1420 may determine a corresponding inter-layer prediction mode according to whether inter-layer prediction has been performed on each slice. The enhancement layer encoder 1420 may generate a slice header including inter-layer prediction mode information of each slice.

In an exemplary embodiment, if the inter-layer prediction is performed on all inter-blocks that are included in a current slice of the enhancement layer image, the slice header may include the inter-layer prediction mode indicating that the inter-layer prediction is performed. Conversely, if the inter-layer prediction is performed on all inter-blocks that are included in the current slice of the enhancement layer image, the slice header may include an inter-layer prediction mode indicating that the inter-layer prediction is not performed.

For example, if an inter-layer prediction mode is set as 1, the prediction information for the enhancement layer image may not be encoded, and the prediction information for the base layer image may be encoded. If the inter-layer prediction mode is set as 0, the prediction information for the enhancement layer image, and the prediction information for the base layer image may be separately encoded.

The inter-layer video encoding apparatus 1400 may output the encoding information of the base layer image, and may output residue encoding information as the encoding information of the enhancement layer image, wherein the residue encoding information excludes information that is derived from the base layer image. Accordingly, an apparatus having received information output from the inter-layer video encoding apparatus 1400 may infer or predict an encoding mode of another enhancement layer image that is not received yet, by referring to the encoding information of the base layer image.

The enhancement layer encoder 1420 may determine a data unit of the base layer image to be referred to by a data unit of the enhancement layer image. For example, a block of the base layer image that is located and corresponds to a position of a current block of the enhancement layer image may be determined. The enhancement layer encoder 1420 may perform prediction encoding on the enhancement layer image by referring to encoding information of the determined block of the base layer.

As described above with reference to FIGS. 1 through 13, the data unit of each of the base layer image and the enhancement layer image may include at least one of a maximum coding unit, a coding unit, and a prediction unit, a transformation unit, and a minimum unit that are included in the coding unit.

The enhancement layer encoder 1420 may determine the data unit of the base layer image which is the same type as a current data unit of the enhancement layer image. For example, the coding unit of the enhancement layer image may refer to the coding unit of the base layer image. The prediction unit of the enhancement layer image may refer to a maximum prediction unit of the base layer image.

In order to determine the data unit of the base layer image, which corresponds to the current data unit of the enhancement layer image, the enhancement layer encoder 1420 may compare samples between upper/base layer images, according to sample accuracy at a sub-pixel level. For example, the enhancement layer encoder 1420 may search for a sample position in an accuracy of a sample position at a 1/12 pixel level, wherein the sample position is of the base layer image that corresponds to the enhancement layer image. In a case of 2× upsampling between lower/enhancement layer images, sample accuracy is required to have an accuracy of sub-pixel levels of a ¼ pixel position and a ¾ pixel position. In a case of 3/2× upsampling, sample accuracy is required to have an accuracy of sub-pixel levels of a ⅓ pixel position and a ⅔ pixel position.

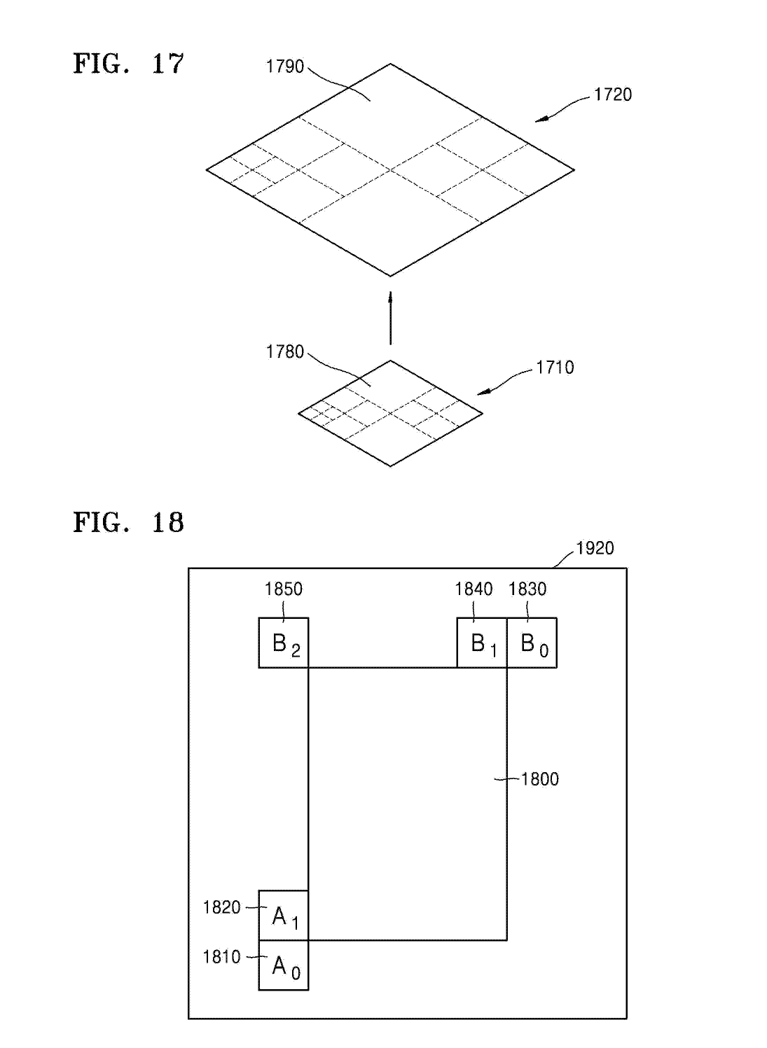

An exemplary embodiment related to mapping data units between the base layer image and the enhancement layer image will be described in detail with reference to FIG. 17.

The inter-layer video encoding apparatus 1400 may perform inter-layer video encoding of prediction information so as to determine prediction information of the enhancement layer image by using prediction information of the base layer image.

The base layer encoder 1410 may perform prediction encoding on blocks of the base layer image. While the base layer image is prediction encoded, the prediction information of the base layer image may be determined.

The enhancement layer encoder 1420 may determine a base layer candidate block that is from among the blocks of the base layer image and corresponds to a position of a current block from among blocks of the enhancement layer image. In an exemplary embodiment, the base layer candidate block that corresponds to the position of the current block may mean a block in the base layer image that is disposed at a position corresponding to the position of the current block in the enhancement layer image.

The enhancement layer encoder 1420 may determine a prediction candidate list including candidate blocks to be referred to in determining prediction information of the current block. The enhancement layer encoder 1420 may determine a reference block for the current block from the prediction candidate list that includes one or more candidate blocks that are included in the enhancement layer image and are spatially adjacent to the current block, and the base layer candidate block.

The enhancement layer encoder 1420 may determine the prediction information of the current block, based on prediction information of the reference block. The enhancement layer encoder 1420 may perform prediction encoding on the current block by using the prediction information.

Thus, the enhancement layer encoder 1420 may use not only prediction information of a spatial candidate block or a temporal candidate block of the current block in the same layer image, but may also determine the prediction information of the current block by using prediction information of a block in another layer image that is disposed at a position corresponding to the position of the current block.

Hereinafter, an operation of performing inter-layer video encoding on prediction information, the operation being performed by the inter-layer video encoding apparatus 1400, will now be described in detail.

The base layer encoder 1410 according to an exemplary embodiment may perform inter-prediction on blocks of the base layer image and may generate prediction information including a motion vector, a prediction direction, and a reference index, and residue information for each of the blocks. A block may indicate a predetermined coding unit, a prediction unit, or a partition from among the coding units of the tree structure.

The enhancement layer encoder 1420 according to an exemplary embodiment may determine the base layer candidate block that is from among the blocks of the base layer image and corresponds to a position of a current block from among inter-mode blocks of the enhancement layer image.

The enhancement layer encoder 1420 according to an exemplary embodiment may determine prediction information of the current block by using prediction information of a spatial candidate block or a temporal candidate block in the enhancement layer image, and the base layer candidate block.

The spatial candidate block may be a block that is spatially adjacent to the current block in the current enhancement layer image. The temporal candidate block may be a block that is from among blocks of another enhancement layer image and is disposed at a position corresponding to a position of the current block in the current enhancement layer image. The base layer candidate block according to an exemplary embodiment may be a block in the base layer image that is disposed at a position corresponding to a position of the current block in the current enhancement layer image.

The enhancement layer encoder 1420 according to an exemplary embodiment may perform inter-prediction on the current block by using prediction information determined for the current block, and may generate residue information.

A slice header according to an exemplary embodiment may include an inter-layer prediction mode indicating whether prediction of prediction information is possible between the base layer image and the enhancement layer image. The enhancement layer encoder 1420 according to an exemplary embodiment may generate a slice header including information indicating that motion vector prediction is possible between the base layer image and the enhancement layer image.

The enhancement layer encoder 1420 according to an exemplary embodiment may convert coordinates of the position of the current block in the enhancement layer image into coordinates in the base layer image, based on a size ratio of the base layer image to the enhancement layer image. The enhancement layer encoder 1420 may reduce the coordinates that were converted to be adapted for the base layer image, may restore the coordinates through a bit-shift operation, and thus, may compress the coordinates.

The enhancement layer encoder 1420 according to an exemplary embodiment may determine, by using the compressed coordinates, a position of the base layer candidate block that corresponds to the position of the current block in the enhancement layer image.

The enhancement layer encoder 1420 according to an exemplary embodiment may determine the base layer candidate block at the position that corresponds to the current block, and may adjust and use a motion vector of the base layer candidate block. For example, the enhancement layer encoder 1420 may scale the motion vector of the base layer candidate block, based on the size ratio of the base layer image to the enhancement layer image, and may determine a motion vector of the current block by using the scaled motion vector. An operation of scaling the motion vector may indicate an operation of adjusting a size of the motion vector, and may include an operation of enlarging or reducing the size of the motion vector, and may also include an operation of maintaining the size.

Thus, the coordinates of the base layer candidate block may be used by using the coordinates of the current block that are converted into the coordinates of the base layer image, and the motion vector that is obtained by scaling the motion vector of the base layer candidate block may be predicted as the motion vector of the current block.

The enhancement layer encoder 1420 according to an exemplary embodiment may add the base layer candidate block to a motion candidate list that includes at least one of a spatial candidate block of the enhancement layer image and a temporal candidate block of another enhancement layer image. The enhancement layer encoder 1420 may compare prediction results of the current block by using a plurality of pieces of prediction information of candidate blocks in the motion candidate list, and thus, may determine a reference block of the current block.

For example, the enhancement layer encoder 1420 may predict a plurality of pieces of candidate prediction information of the current block by using the plurality of pieces of prediction information of the candidate blocks in the motion candidate list, may compare results of performing inter-prediction by using the plurality of pieces of candidate prediction information, may determine optimal prediction information with a highest encoding efficiency, and thus, may determine a candidate block as the reference block of the current block, wherein the optimal prediction information is allocated to the candidate block.

The enhancement layer encoder 1420 according to an exemplary embodiment may determine the prediction information of the current block by referring to prediction information of the reference block. In this case, as described above, the motion vector of the base layer candidate block may be scaled based on the size ratio of the base layer image to the enhancement layer image, and the scaled motion vector may be used in predicting the prediction information of the current block.

According to whether a prediction mode of prediction information is a merge mode or not, a method of performing the inter-layer video encoding on the prediction information may vary.

For example, if a prediction mode of the prediction information of the current block is the merge mode, the enhancement layer encoder 1420 may determine the prediction information of the current block by using a motion vector, a prediction direction, and a reference index in the prediction information of the reference block. Also, the enhancement layer encoder 1420 may further generate and output a candidate list index indicating the determined reference block from the candidate list.

As another example, if the prediction mode of the prediction information of the current block is not the merge mode, the enhancement layer encoder 1420 may determine a motion vector, a prediction direction, and a reference index of the current block by using the motion vector, the prediction direction, and the reference index in the prediction information of the reference block. The enhancement layer encoder 1420 may further generate and output a difference motion vector between the motion vector of the base layer candidate block and the motion vector of the reference block, and a candidate list index.

Hereinafter, an operation of performing inter-layer video encoding on prediction information according to intra-prediction, the operation being performed by the inter-layer video encoding apparatus 1400, will now be described in detail.

The base layer encoder 1410 according to another exemplary embodiment may generate intra-index information for each of blocks of the base layer image by performing intra-prediction on each of the blocks.

The enhancement layer encoder 1420 according to another exemplary embodiment may determine the base layer candidate block that is from among the blocks of the base layer image and corresponds to a position of a current block from among the enhancement layer image. The enhancement layer encoder 1420 may determine an intra-index of the current block, based on uniformity between intra-indexes of two or more blocks that are spatially adjacent to the current block, and an intra-index of the base layer candidate block.

For example, in order to determine the intra-index of the current block, the enhancement layer encoder 1420 may use three candidate intra-indexes of three reference blocks.

If a left neighboring block and an upper neighboring block of the current block, and the base layer candidate block have a common intra-index, and the common intra-index is a predetermined intra-index, e.g., if the common intra-index is a first intra-index or a second intra-index, the enhancement layer encoder 1420 according to another exemplary embodiment may fixedly set the three candidate intra-indexes of the current block as the first intra-index, the second intra-index, and another predetermined third intra-index, respectively.

If the left neighboring block and the upper neighboring block of the current block, and the base layer candidate block have a common intra-index, and the common intra-index is neither the first intra-index nor the second intra-index, the enhancement layer encoder 1420 according to another exemplary embodiment may set the three candidate intra-indexes of the current block as the common intra-index, and two intra-indexes that are adjacent to the common intra-index, respectively.

If two blocks of the left neighboring block and the upper neighboring block of the current block, and the base layer candidate block have a common intra-index, the enhancement layer encoder 1420 according to another exemplary embodiment may set the three candidate intra-indexes of the current block as the common intra-index of the two blocks, an intra-index of the other block of the two blocks, and the first intra-index.

If intra-indexes of the left neighboring block and the upper neighboring block of the current block, and the base layer candidate block are different from each other, the enhancement layer encoder 1420 according to another exemplary embodiment may set the three candidate intra-indexes of the current block as an intra-index of the left neighboring block, an intra-index of the upper neighboring block, and an intra-index of the base layer candidate block.

Thus, the enhancement layer encoder 1420 according to another exemplary embodiment may perform intra prediction on the current block by using an intra-index of a neighboring block in the same layer image, and an intra-index that is determined in consideration of an intra-mode of a collocated block in another layer image.

In one or more exemplary embodiments, the base layer image and the enhancement layer image may differ in terms of resolutions. For example, a resolution of the current block of the enhancement layer image may be 16×16, and a resolution of the base layer image may be 4×4.

The base layer encoder 1410 according to one or more exemplary embodiments may perform entropy encoding on the prediction information and the residue information that were generated for each of the blocks of the base layer image, and thus, may output a base layer stream. Similarly, the enhancement layer encoder 1420 may perform entropy encoding on the residue information that was generated for each of the blocks of the enhancement layer image, and thus, may output an enhancement layer stream. However, other prediction information that is not predicted from the prediction information of the base layer image may be entropy encoded in the same manner as the residue information, and thus may be output as the enhancement layer stream.

The inter-layer video encoding apparatus 1400 according to one or more exemplary embodiments may transmit the base layer stream and the enhancement layer stream via a separate transmission channel.

The inter-layer video encoding apparatus 1400 according to one or more exemplary embodiments performs encoding, based on the coding units of the tree structure, and thus may be related to the video encoding apparatus 100 according to an exemplary embodiment.

For example, the base layer encoder 1410 of the inter-layer video encoding apparatus 1400 may encode the base layer image, based on the coding units of the tree structure, according to operations by the maximum coding unit splitter 110, the coding unit determiner 120, and the output unit 130 of the video encoding apparatus 100. The coding unit determiner 120 may determine the encoding mode of the data unit such as the coding unit, the prediction unit, the transformation unit, or a partition of the base layer image. Similar to an operation by the output unit 130, the base layer encoder 1410 may output the encoding information that is determined for each data unit of the base layer image and includes the encoding mode and an encoded prediction value.

For example, the enhancement layer encoder 1420 may also perform encoding according to operations by the maximum coding unit splitter 110, the coding unit determiner 120, and the output unit 130. The encoding operation by the enhancement layer encoder 1420 may be similar to the operation by the coding unit determiner 120 but may refer to the encoding information of the base layer image so as to determine the encoding information for the enhancement layer image, based on the inter-layer prediction mode. Also, the enhancement layer encoder 1420 may perform an operation similar to the operation by the output unit 130 but may not selectively encode the encoding information of the enhancement layer, based on the inter-layer prediction mode.

The inter-layer video encoding apparatus 1400 according to one or more exemplary embodiments may include a central processor (not shown) that generally controls the base layer encoder 1410 and the enhancement layer encoder 1420. Alternatively, the base layer encoder 1410 and the enhancement layer encoder 1420 may operate using their own processors (not shown), respectively, and since the processors interoperate with each other, the inter-layer video encoding apparatus 1400 may operate, accordingly. Alternatively, according to control by an external processor (not shown) of the inter-layer video encoding apparatus 1400, the base layer encoder 1410 and the enhancement layer encoder 1420 may be controlled.

The inter-layer video encoding apparatus 1400 according to one or more exemplary embodiments may include one or more data storage units (not shown) for storing input and output data of the base layer encoder 1410 and the enhancement layer encoder 1420. The video encoding apparatus 100 may include a memory control unit (not shown) that controls data input and output of the one or more data storage units.

The inter-layer video encoding apparatus 1400 according to one or more exemplary embodiments may interoperate with an internal video encoding processor that is internally embedded or an external video encoding processor so as to output a video encoding result, so that the multi-view video inter-layer video encoding apparatus 1400 may perform a video encoding operation including transformation. The internal video encoding processor of the inter-layer video encoding apparatus 1400 according to one or more exemplary embodiments may correspond to not only a separate processor but also may correspond to a case in which a central processing unit or a graphical operational unit of the inter-layer video encoding apparatus 1400 includes a video encoding processing module and thus performs a basic video encoding operation.

FIG. 15 is a block diagram of an inter-layer video decoding apparatus 1500 for prediction information, according to one or more exemplary embodiments.

The inter-layer video decoding apparatus 1500 according to one or more exemplary embodiments includes a base layer decoder 1510 and an enhancement layer decoder 1520.

The inter-layer video decoding apparatus 1500 according to one or more exemplary embodiments may receive bitstreams according to layers, based on a scalable encoding method. The bitstreams that include inter-layer prediction encoded video data may be received according to the layers. The number of layers of the bitstreams that the inter-layer video decoding apparatus 1500 receive is not limited. However, for convenience of description, hereinafter, in an exemplary embodiment, the base layer decoder 1510 receives a base layer bitstream and an enhancement layer bitstream.

The base layer decoder 1510 may parse encoding information of a base layer image from the base layer bitstream. An encoding mode and a plurality of pieces of encoded data of the base layer image may be parsed from the base layer bitstream.

The enhancement layer decoder 1520 may parse an inter-layer prediction mode and encoded data of an enhancement layer image.

The base layer decoder 1510 may decode the base layer image by using the parsed encoding information of the base layer image. In a case where the inter-layer video encoding apparatus 1400 encodes a video, based on coding units of a tree structure, the base layer decoder 1510 may perform decoding on each maximum coding unit of the base layer image, based on the coding units of the tree structure.

The enhancement layer decoder 1520 may decode the enhancement layer image by using the encoding information of the base layer image that is decoded in the base layer decoder 1510.

The enhancement layer decoder 1520 may prediction decode an encoding mode of the enhancement layer image according to the inter-layer prediction mode of the parsed enhancement layer image, by referring to the encoding mode of the base layer image. For example, a prediction mode of the enhancement layer image may be determined according to the inter-layer prediction mode, in consideration of prediction information of the base layer image.

For example, if the inter-layer prediction mode is 1, encoding information for the enhancement layer image may not be obtained from the bitstreams but the encoding information for the base layer image may be obtained from the bitstreams. The encoding information for the enhancement layer image may be determined by using the encoding information for the base layer image. If the inter-layer prediction mode is 0, prediction information for the enhancement layer image, and the prediction information for the base layer image may be separately obtained from the bitstreams.

When the inter-layer prediction mode is 1, the enhancement layer decoder 1520 may determine the prediction information of the enhancement layer image by using the prediction information from among the encoding mode of the base layer image. For example, from among the prediction information of the enhancement layer image, the prediction mode information indicating an inter-mode or an intra-mode, and partition type information indicating a partition size or a partition split direction may be determined from the prediction information of the base layer image. If it is the inter-mode, motion information for motion compensation of the enhancement layer image may be determined from the prediction information of the base layer image. If it is the intra-mode, an intra-index for intra-prediction of the enhancement layer image may be determined from the prediction information of the enhancement layer image.

The enhancement layer decoder 1520 may parse residue information, which excludes information determined from the encoding mode of the base layer image, from an enhancement layer stream. In other words, the enhancement layer decoder 1520 may determine an encoding mode of an enhancement layer image, without parsing the encoding mode of an enhancement layer image, from the encoding mode of the base layer image.

Also, the enhancement layer decoder 1520 may determine a data unit of the base layer image to be referred to by a data unit of the enhancement layer image, according to the inter-layer prediction mode of the enhancement layer image that is parsed from the bitstream. That is, the data unit of the base layer image that is mapped to a position corresponding to a position of the data unit of the enhancement layer image may be determined. In an exemplary embodiment, when the base layer image is decoded based on the coding units of the tree structure, a prediction unit, and a transformation unit, the enhancement layer image may also be decoded based on the coding units of the tree structure, the prediction unit, and the transformation unit. An encoding mode of the data unit of the enhancement layer image may be determined, in consideration of an encoding mode allocated to the data unit of the base layer image.

The enhancement layer decoder 1520 may determine a data unit of the base layer image that is a same type as, and is disposed at a position corresponding to a position of, a current data unit of the enhancement layer image. For example, an encoding mode of a coding unit of the enhancement layer image may be determined by using an encoding mode of a coding unit of the base layer image. The prediction information of the prediction unit of the enhancement layer image may be determined by using the prediction information of the prediction unit of the base layer image.

In an exemplary embodiment, the inter-prediction may be performed according to a sample accuracy at a sub-pixel level. The enhancement layer decoder 1520 may search for a position of a sample of the base layer image that corresponds to a sample of the enhancement layer image, according to sample accuracy at a sub-pixel level, so as to determine the prediction unit of the base layer image that corresponds to a current prediction unit of the enhancement layer image.

The inter-layer video decoding apparatus 1500 may perform inter-layer video decoding on the prediction information. First, the base layer decoder 1510 may obtain the prediction information of the base layer image, may perform the motion compensation or the intra-prediction on the base layer image by using the prediction information, and thus may restore the base layer image.

The enhancement layer decoder 1520 may determine the prediction information of the enhancement layer image by using the prediction information of the base layer image, may perform the motion compensation or the intra-prediction on the enhancement layer image by using the prediction information, and thus may restore the enhancement layer image.

In more detail, the enhancement layer decoder 1520 may determine a base layer candidate block from among blocks of the base layer image, wherein the base layer candidate block is disposed at a position corresponding to a position of a current block from among blocks of the enhancement layer image.

The enhancement layer decoder 1520 may determine a reference block for the current block from a prediction candidate list that includes one or more candidate blocks in a same layer image as the current block, and the base layer candidate block. The enhancement layer decoder 1520 may determine prediction information of the current block of the enhancement layer image, based on prediction information of the reference block.

The enhancement layer decoder 1520 may perform decoding on the current block by using the prediction information that is determined based on the reference block, and thus may restore the current block.

Thus, the enhancement layer decoder 1520 may determine the prediction information of the current block, by referring to prediction information of a spatial candidate block or a temporal candidate block of the current block in the same layer image and by using prediction information of a candidate block of another layer image that is disposed at a position corresponding to a position of the current block.

Hereinafter, an operation of performing inter-layer video decoding on prediction information for motion compensation, the operation being performed by the inter-layer video decoding apparatus 1500 according to an exemplary embodiment, will now be described.

The base layer decoder 1510 according to an exemplary embodiment may obtain, from a base layer stream, prediction information including a motion vector, a prediction direction, and a reference index, and residue information that are allocated to each of blocks. The block may be a predetermined coding unit, a prediction unit, or a partition from among coding units of a tree structure. The base layer decoder 1510 may perform motion compensation on blocks of a base layer image, by using the obtained prediction information and residue information.

The enhancement layer decoder 1520 according to an exemplary embodiment may obtain, from a slice header of an enhancement layer stream, inter-layer prediction mode information indicating whether prediction of prediction information is possible between the base layer image and an enhancement layer image. That is, the enhancement layer decoder 1520 according to an exemplary embodiment may decide whether to perform inter-layer prediction of the prediction information on each slice, based on the inter-layer prediction mode information included in the slice header.

When information indicating that motion vector prediction is possible between the base layer image and the enhancement layer image is obtained from the slice header, the enhancement layer decoder 1520 according to an exemplary embodiment may determine prediction information for motion compensation of the enhancement layer image by using prediction information for motion compensation of the base layer image.

The enhancement layer decoder 1520 according to an exemplary embodiment may determine a base layer candidate block of the base layer image that corresponds to a position of an inter-mode current block in the enhancement layer image, and may determine prediction information for motion compensation of the current block by using prediction information for motion compensation of the base layer candidate block.

The enhancement layer decoder 1520 according to an exemplary embodiment may perform motion compensation on the current block by using the prediction information determined from the base layer image, and residue information of the current block that is obtained from the enhancement layer stream. The current block may be restored via the motion compensation.

The enhancement layer decoder 1520 according to an exemplary embodiment may convert coordinates indicating a position of the current block of the enhancement layer image into coordinates in the base layer image, based on a size ratio of the base layer image to the enhancement layer image. The enhancement layer decoder 1520 may reduce and restore the coordinates through a bit-shift operation and thus may compress the coordinates, so that the enhancement layer decoder 1520 may determine a position of the base layer candidate block that corresponds to the current block, by using the compressed coordinates.

The enhancement layer decoder 1520 according to an exemplary embodiment may scale a motion vector of the base layer candidate block, based on the size ratio of the base layer image to the enhancement layer image. A motion vector of the current block may be determined by using the scaled motion vector.

Thus, the coordinates of the current block of the enhancement layer image may be changed by having been converted into and compressed as the coordinates of the base layer image, and the motion vector of the base layer candidate block that was determined by using the changed coordinates may be scaled to obtain the motion vector of the enhancement layer image and thus may be used as the motion vector of the reference block.

The enhancement layer decoder 1520 according to an exemplary embodiment may add the base layer candidate block to a motion candidate list including at least one of a spatial candidate block of the enhancement layer image and a temporal candidate block of another enhancement layer image. The enhancement layer decoder 1520 may determine the reference block of the current block from the motion candidate list, by using a candidate list index obtained from the enhancement layer stream. The prediction information of the current block may be determined by using the prediction information of the reference block.

Depending on whether a prediction mode of the prediction information is a merge mode or not, an inter-layer video decoding method with respect to the prediction information may vary.

For example, if the prediction mode of the prediction information of the current block is the merge mode, the enhancement layer decoder 1520 according to an exemplary embodiment may obtain the residue information and the candidate list index from the enhancement layer stream. The enhancement layer decoder 1520 according to an exemplary embodiment may determine the prediction information of the current block by using a motion vector, a prediction direction, and a reference index from among the prediction information of the reference block.

For example, if the prediction mode of the prediction information of the current block is not the merge mode, the enhancement layer decoder 1520 according to an exemplary embodiment may obtain the residue information, the candidate list index, and a difference motion vector from the enhancement layer stream. The difference motion vector is combined with the motion vector from among the prediction information of the reference block, so that the motion vector of the current block may be determined.

The base layer decoder 1510 according to an exemplary embodiment may perform entropy decoding on the base layer stream, and may obtain prediction information and residue information from each of the blocks of the base layer image. The enhancement layer decoder 1520 according to an exemplary embodiment may perform entropy decoding on the enhancement layer stream, and may obtain residue information from each of the blocks of the enhancement layer image.

The base layer decoder 1510 according to an exemplary embodiment may restore inter-prediction mode blocks by performing motion compensation by using prediction information and residue information that are obtained for the inter-prediction mode blocks of the base layer image. One of the motion compensation and the intra-prediction is performed on each of the blocks of the base layer image according to the prediction mode, so that the base layer image may be restored.

The enhancement layer decoder 1520 according to an exemplary embodiment may perform the motion compensation on the inter-prediction mode blocks by using the prediction information determined for each block of the enhancement layer image, and by using the residue information of the blocks of the enhancement layer image that was obtained from the enhancement layer stream. One of the motion compensation and the intra-prediction is performed on each of the blocks of the enhancement layer image according to the prediction mode, so that the enhancement layer image may be restored.

Hereinafter, an operation of performing inter-layer video decoding on prediction information for intra-prediction, the operation being performed by the inter-layer video decoding apparatus 1500 according to another exemplary embodiment, will now be described.

The base layer decoder 1510 according to an exemplary embodiment may obtain, from a base layer stream, an intra-index that is allocated to intra-mode blocks from among blocks of a base layer image. The block may be a predetermined coding unit, a prediction unit, or a partition from among coding units of a tree structure. The base layer decoder 1510 may perform, by using the obtained intra-index, intra-prediction on the intra-mode blocks of the base layer image.

The enhancement layer decoder 1520 according to an exemplary embodiment may determine a base layer candidate block of the base layer image that corresponds to a position of an intra-mode current block of an enhancement layer image. The enhancement layer decoder 1520 according to an exemplary embodiment may determine an intra-index of the current block, based on uniformity of intra-indexes of two or more blocks that are spatially adjacent to the current block, and the intra-index of the base layer candidate block.

That is, the intra-index of the current block may be determined, in consideration of all of the intra-indexes of the blocks that are spatially adjacent to the current block and are in the same layer image as the current block, and an intra-index of a block in another layer image.

For example, the enhancement layer decoder 1520 according to an exemplary embodiment may use three candidate intra-indexes of three reference blocks so as to determine the intra-index of the current block. The enhancement layer decoder 1520 according to an exemplary embodiment may determine the intra-index from among the candidate intra-indexes, wherein the intra-index is indicated by a candidate list index for the current block that is obtained from an enhancement layer stream.

For example, if a left neighboring block and an upper neighboring block of the current block, and the base layer candidate block have a common intra-index, and the common intra-index is a predetermined intra-index, e.g., a first intra-index or a second intra-index, the enhancement layer decoder 1520 according to an exemplary embodiment may fixedly set the three candidate intra-indexes of the current block as the first intra-index, the second intra-index, and a third intra-index that is another predetermined intra-index, respectively.

For example, if the left neighboring block and the upper neighboring block of the current block, and the base layer candidate block have a common intra-index, and the common intra-index is neither the first intra-index nor the second intra-index, the enhancement layer decoder 1520 according to an exemplary embodiment may set the three candidate intra-indexes of the current block as the common intra-index, and two intra-indexes that are adjacent to the common intra-index, respectively.

For example, if two blocks from among the left neighboring block and the upper neighboring block of the current block, and the base layer candidate block have a common intra-index, the enhancement layer decoder 1520 according to an exemplary embodiment may set the three candidate intra-indexes of the current block as the common intra-index of the two blocks, an intra-index of the other block of the two blocks, and the first intra-index.

For example, if intra-indexes of the left neighboring block and the upper neighboring block of the current block, and the base layer candidate block are different, the enhancement layer decoder 1520 according to an exemplary embodiment may set the three candidate intra-indexes of the current block as the intra-index of the left neighboring block, the intra-index of the upper neighboring block, and the intra-index of the base layer candidate block.

The enhancement layer decoder 1520 according to an exemplary embodiment may perform intra-prediction on the current block by using the intra-index that is determined from among the candidate intra-indexes, and thus may restore the current block.

In the one or more exemplary embodiments, a resolution of the current block of the enhancement layer image may be 16×16, and a resolution of the base layer image may be 4×4.

Thus, the inter-layer video decoding apparatus 1500 according to the one or more exemplary embodiments may separately restore the base layer image and the enhancement layer image that are received from different layers.

The inter-layer video decoding apparatus 1500 according to the one or more exemplary embodiments performs decoding based on the coding units of the tree structure and thus may be related to the video decoding apparatus 200 according to the one or more exemplary embodiments.

For example, the base layer decoder 1510 and the enhancement layer decoder 1520 of the inter-layer video decoding apparatus 1500 may receive a bitstream according to operations of the receiver 210 of the video decoding apparatus 200, and then may parse the encoding information about the base layer image and the encoding information about the enhancement layer image according to operations of the image data and encoding information extractor 220 of the video decoding apparatus 200. The base layer decoder 1510 may parse the encoding information with respect to the data unit such as the coding unit, the prediction unit, the transformation unit, or the partition of the base layer image. Here, the enhancement layer decoder 1520 may selectively not parse the encoding information about the enhancement layer image, based on the inter-layer video encoding.

For example, similar to an operation by the image data decoder 230 of the video decoding apparatus 200, the base layer decoder 1510 may decode the base layer image based on coding units of the tree structure by using the parsed encoding information.

Similar to the operation by the image data decoder 230 of the video decoding apparatus 200, the enhancement layer decoder 1520 may decode the enhancement layer image based on the coding units of the tree structure by using the parsed encoding information. Here, the enhancement layer decoder 1520 may determine the encoding information for the enhancement layer image by referring to the encoding information of the base layer image, according to the inter-layer prediction mode, and then may perform decoding.

The inter-layer video decoding apparatus 1500 according to the one or more exemplary embodiments may include a central processor (not shown) that generally controls the base layer decoder 1510 and the enhancement layer decoder 1520. Alternatively, the base layer decoder 1510 and the enhancement layer decoder 1520 may operate by using their own processors (not shown), respectively, and since the processors interoperate with each other, the inter-layer video decoding apparatus 1500 may operate, accordingly. Alternatively, according to control by an external processor (not shown) of the inter-layer video decoding apparatus 1500 according to the one or more exemplary embodiments, the base layer decoder 1510 and the enhancement layer decoder 1520 may be controlled.

The inter-layer video decoding apparatus 1500 according to the one or more exemplary embodiments may include one or more data storage units (not shown) for storing input and output data of the base layer decoder 1510 and the enhancement layer decoder 1520. The inter-layer video decoding apparatus 1500 may include a memory controller (not shown) that controls data input and output of the one or more data storage units.

In order to restore a video by decoding the video, the inter-layer video decoding apparatus 1500 according to the one or more exemplary embodiments may interoperate with an internal video decoding processor that is internally embedded, or an external video decoding processor, so that the inter-layer video decoding apparatus 1500 may perform a video decoding operation including inverse-transformation. The internal video decoding processor of the inter-layer video decoding apparatus 1500 according to the one or more exemplary embodiments may correspond to not only a separate processor but also may correspond to a case in which a central processing unit or a graphical operational unit of the inter-layer video decoding apparatus 1500 includes a video encoding processing module and thus performs a basic video encoding operation.

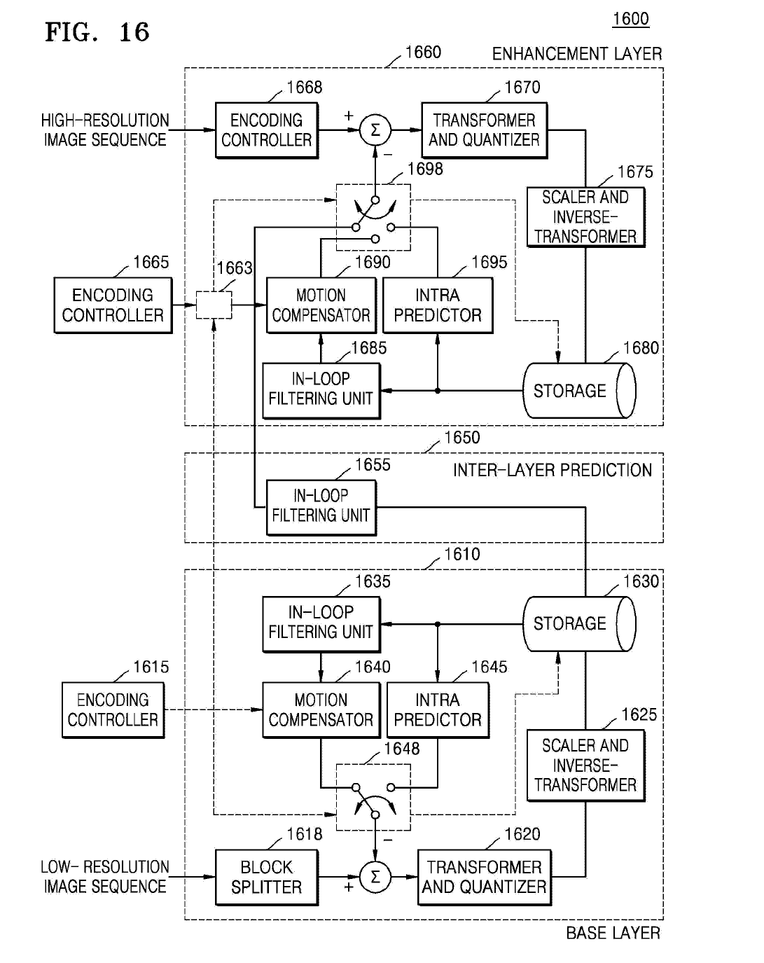

Hereinafter, with reference to FIGS. 16 through 22, inter-layer prediction methods performed by the inter-layer video encoding apparatus 1400 and the inter-layer video decoding apparatus 1500 are described in detail.

FIG. 16 is a block diagram of an inter-layer video encoding system 1600, according to one or more exemplary embodiments.

The inter-layer video encoding system 1600 includes a base layer encoding end 1610, an enhancement layer encoding end 1660, and an inter-layer prediction end 1650 between the base layer encoding end 1610 and the enhancement layer encoding end 1660. The base layer encoding end 1610 and the enhancement layer encoding end 1660 may have detailed structures of the base layer encoder 1410 and the enhancement layer encoder 1420, respectively.

The base layer encoding end 1610 receives a base layer image sequence and encodes every image. The enhancement layer encoding end 1660 receives an additional layer image sequence and encodes every image. Operations that overlap with each other among operations by the base layer encoding end 1610 and the enhancement layer encoding end 1660 are simultaneously described.

An input image (a low-resolution image or a high-resolution image) is split into a maximum coding unit, a coding unit, a prediction unit, or a transformation unit via a block splitter 1618 or 1668. In order to encode the coding unit output from the block splitter 1618 or 1668, intra-prediction or inter-prediction may be performed on each of prediction units of the coding unit, according to a prediction mode.

A prediction switch 1648 or 1698 may be connected to a motion compensator 1640 or 1690, if the prediction mode of the prediction unit is an inter-mode. For the prediction during the inter-mode, the inter-prediction may be performed by referring to a previous restored image output from the motion compensator 1640 or 1690. Residue information may be generated for each of the prediction units via the inter-prediction.

Alternatively, the prediction switch 1648 or 1698 may be connected to an intra predictor 1645 or 1695, if the prediction mode of the prediction unit is an intra-mode. The intra-prediction may be performed by using a neighboring prediction unit of a current prediction unit in a current input image that is output from the intra predictor 1645 or 1695.

According to each prediction unit, residue information about each prediction unit and an adjacent image is input to a transformer and quantizer 1620 or 1670. The transformer and quantizer 1620 or 1670 may output a quantized transform coefficient by performing transformation and quantization on each of transformation units, based on the transformation units of the coding unit.

A scaler and inverse-transformer 1625 or 1675 may perform scaling and inverse-transformation on the quantized transform coefficient according to each of the transformation units of the coding unit, and thus may generate residue information about a spatial domain. When the inter mode is indicated by control of the prediction switch 1648 or 1698, the residue information is combined with the previous restored image or the neighboring prediction unit, so that a restored image including the current prediction unit may be generated, and a current restored image may be stored in storage 1630 or 1680. The current restored image may be transferred to the intra predictor 1645 or 1695 and the intra predictor 1645 or 1695 according to a prediction mode of a prediction unit to be encoded next time.

In the inter mode, an in-loop filtering unit 1635 or 1685 may perform at least one of deblocking filtering and Sample Adaptive Offset (SAO) filtering on a restored image stored in the storage 1630 or 1680, according to each of coding units. At least one of the deblocking filtering and the SAO filtering may be performed on the coding unit and at least one of a prediction unit and a transformation unit that are included in the coding unit.

The deblocking filtering is filtering for lessening a blocking phenomenon of a data unit, and the SAO filtering is filtering for compensating for an error of a pixel value that is changed due to data encoding and decoding. Data that is filtered by the in-loop filtering unit 1635 or 1685 may be transferred to the motion compensator 1640 or 1690 according to each of the prediction units. In order to encode a next target coding unit that is output from the block splitter 1618 or 1668, residue information about the next target coding unit and the current restored image that is output from the motion compensator 1640 or 1690 and the block splitter 1618 or 1668 may be generated.

In this manner, the aforementioned encoding operations may be repeated on each of the coding units of the input image.

For the inter-layer prediction, the enhancement layer encoding end 1660 may refer to the restored image in the storage 1630 of the base layer encoding end 1610. An encoding controller 1615 of the base layer encoding end 1610 may transfer the restored image of the base layer encoding end 1610 to the enhancement layer encoding end 1660 by controlling the storage 1630 of the base layer encoding end 1610. In the inter-layer prediction end 1650, an in-loop filtering unit 1655 may perform at least one of the deblocking filtering and the SAO filtering on a restored base layer image that is output from the storage 1630 of the base layer encoding end 1610. When the base layer image and the enhancement layer image have different resolutions, the inter-layer prediction end 1650 may perform upsampling on the restored image of the base layer and may deliver the upsampled restored image to the enhancement layer encoding end 1660. When the inter-layer prediction is performed by control of the switch 1698 of the enhancement layer encoding end 1660, inter-layer prediction may be performed on the enhancement layer image by referring to the restored base layer image that is delivered by the inter-layer prediction end 1650.

For image encoding, various encoding modes for the coding unit, the prediction unit, and the transformation unit may be set. For example, a depth or split information (e.g., a split flag) may be set as the encoding mode for the coding unit. A prediction mode, a partition type, intra direction information, or reference list information may be set as the encoding mode for the prediction unit. A transformation depth or split information may be set as the encoding mode of the transformation unit.

The base layer encoding end 1610 may perform encoding by applying each of various depths for the coding unit, each of various prediction modes for the prediction unit, each of various partition types, each of various intra directions, each of various reference lists, and each of various transformation depths for the transformation unit, and then may determine a coded depth, a prediction mode, a partition type, intra direction/reference list, a transformation depth, or the like which achieve highest encoding efficiency, according to a result of the encoding. Examples of an encoding mode that is determined by the base layer encoding end 1610 are not limited to the aforementioned encoding modes.

The encoding controller 1615 of the base layer encoding end 1610 may control various encoding modes to be appropriately applied to operations of each element. Also, for inter-layer video encoding on prediction information by the enhancement layer encoding end 1660, an encoding controller 1665 of the enhancement layer encoding end 1660 may control the enhancement layer encoding end 1660 to determine an encoding mode or residue information by referring to the encoding result of the base layer encoding end 1610.

For example, the enhancement layer encoding end 1660 may changelessly use an encoding mode of the base layer encoding end 1610 as an encoding mode for the enhancement layer image or may determine the encoding mode for the enhancement layer image by referring to the encoding mode of the base layer encoding end 1610.

The encoding controller 1615 of the base layer encoding end 1610 may control a control signal of an encoding controller 1665 of the enhancement layer encoding end 1660, so that the enhancement layer encoding end 1660 may use a current encoding mode from the encoding mode of the base layer encoding end 1610 so as to determine the current encoding mode.

Also, based on an inter-layer prediction mode 1663 indicating whether the prediction information is inter-layer predicted or a restored value is inter-layer predicted, a motion vector obtained from the base layer encoding end 1610 may be transferred to the motion compensator 1690, or a restored block obtained from the base layer encoding end 1610 may be used as the reference block for the inter-prediction.

Similar to the inter-layer video encoding system 1600 shown in FIG. 16, an inter-layer video decoding system may be implemented. That is, the inter-layer video decoding system may receive a base layer bitstream and an enhancement layer bitstream. A base layer decoding end of the inter-layer video decoding system may decode the base layer bitstream and thus may generate restored images, so that a low resolution image sequence may be restored. An enhancement layer decoding end of the inter-layer video decoding system may decode the enhancement layer bitstream by using the restored base layer images and parsed encoding information, and thus may generate restored enhancement layer images, so that a high resolution image sequence may be restored.

FIG. 17 illustrates a mapping relation between a base layer and an enhancement layer, according to one or more exemplary embodiments.

In particular, FIG. 17 illustrates the mapping relation between the base layer and the enhancement layer for inter-layer prediction based on coding units of a tree structure. A base layer candidate data unit that is determined as a collocated data unit corresponding to an enhancement layer data unit may be called ‘reference layer data unit’.

In an exemplary embodiment, for the inter-layer prediction, a position of a base layer maximum coding unit 1710 that corresponds to an enhancement layer maximum coding unit 1720 may be determined. For example, to which data unit among base layer data units a sample 1780 that corresponds to an upper left sample 1790 of the enhancement layer maximum coding unit 1720 belongs is examined, and thus, it is determined that the base layer maximum coding unit 1710 including the sample 1780 that is an upper left sample is a data unit that corresponds to the enhancement layer maximum coding unit 1720.

If a structure of the enhancement layer coding unit is inferable from a structure of the base layer coding unit via the inter-layer prediction, a tree structure of coding units that are included in the enhancement layer maximum coding unit 1720 may be determined to be equal to a tree structure of coding units that are included in the base layer maximum coding unit 1710.

Similar to the coding unit, a size of a partition (a prediction unit) or a transformation unit included in the coding units according to the tree structure may vary according to a size of a corresponding coding unit. Also, although partitions or transformation units are included in coding units having a same size, sizes of the partitions or the transformation units may be changed according to a partition type or a transformation depth. Thus, for the partitions or the transformation units based on the coding units of the tree structure, a position of a base layer partition or a base layer transformation unit that correspond to an enhancement layer partition or an enhancement layer transformation unit may be separately determined.

In FIG. 17, in order to determine a reference layer maximum coding unit for the inter-layer prediction, a position of a predetermined data unit 1780 of the base layer maximum coding unit 1710 that corresponds to a position of the upper left sample 1790 of the enhancement layer maximum coding unit 1720 was examined. Similarly, a reference layer data unit may be determined by examining the position of the base layer data unit, positions of centers, or predetermined positions that correspond to a lower right sample of the enhancement layer data unit.

Referring to FIG. 17, maximum coding units of another layer are mapped for the inter-layer prediction, and in this regard, data units of the other layer may be mapped with respect to various coding units that include a maximum coding unit, a coding unit, a prediction unit, a partition, a transformation unit, a minimum unit, or the like.

Thus, in order to determine a reference layer data unit that corresponds to the enhancement layer data unit for the inter-layer prediction, the base layer data unit may be upsampled by a spatial resizing ratio or spatial aspect ratio of a resolution. Also, an upsampled position may be moved by the reference offset, so that a position of the reference layer data unit may be exactly determined. Information about the reference offset may be directly exchanged between the inter-layer video encoding apparatus 1400 for prediction information and the inter-layer video decoding apparatus 1500 for the prediction information. Although the information about the reference offset is not directly exchanged, the reference offset may be predicted according to adjacent motion information, disparity information, or a geometrical shape of the enhancement layer data unit.

Encoding information about a position of the reference layer data unit that corresponds to a position of the enhancement layer data unit may be used for inter-layer prediction with respect to the enhancement layer data unit. For example, prediction information of the enhancement layer data unit may be determined by using prediction information of the base layer prediction unit.

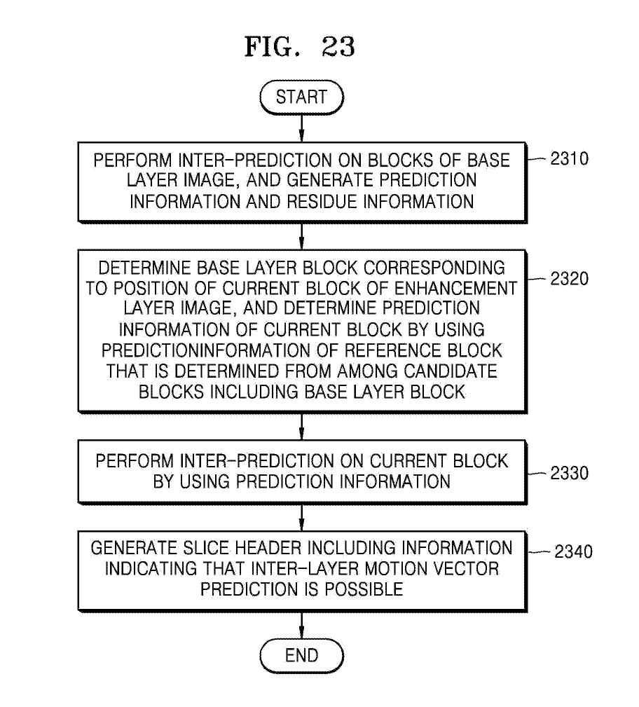

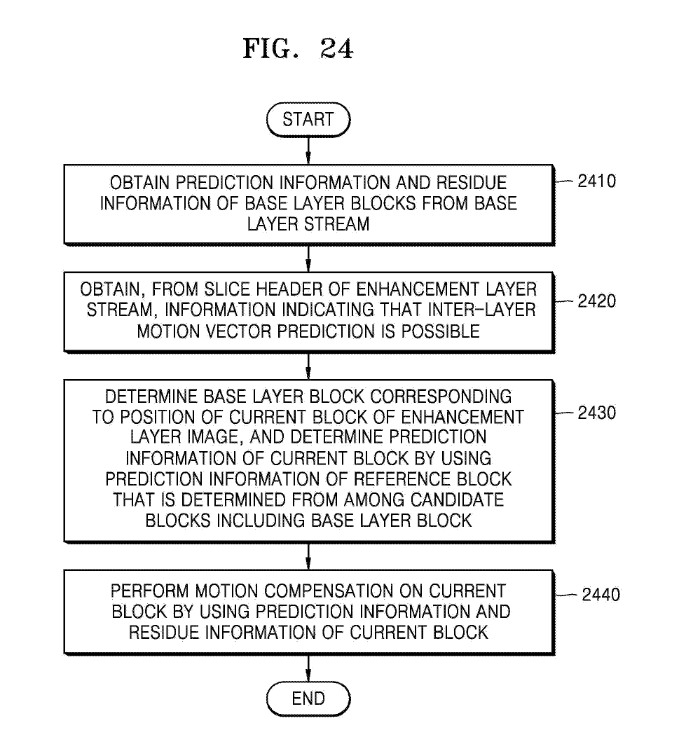

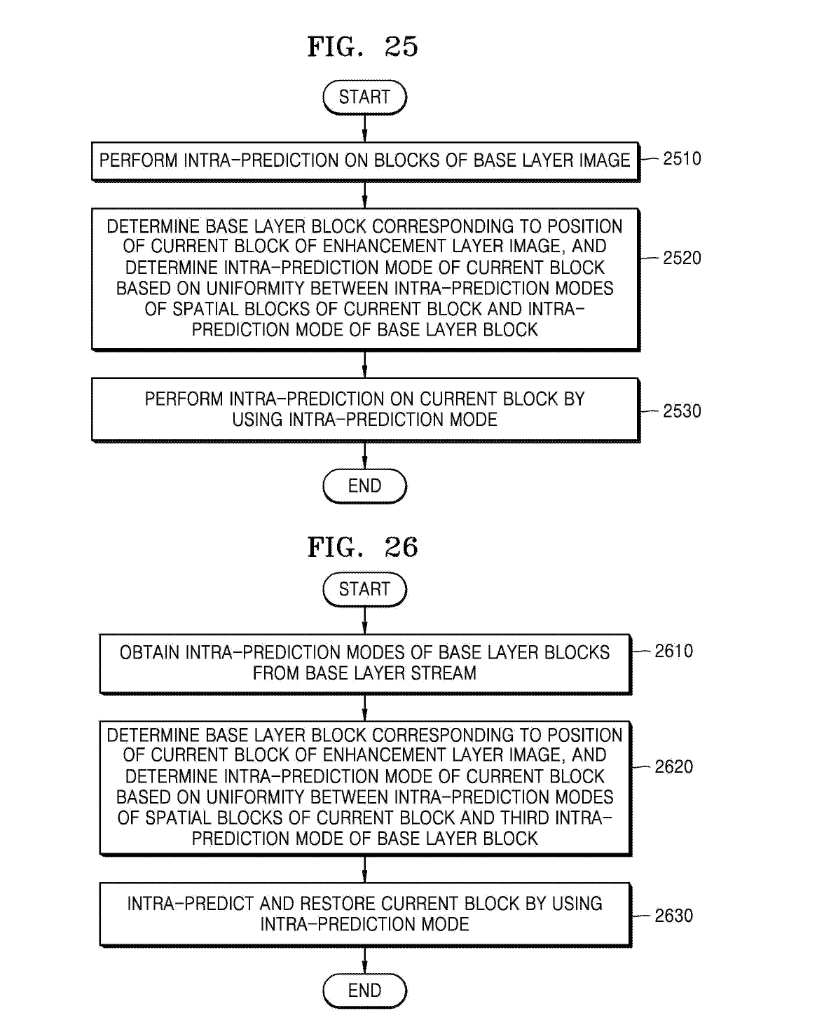

In one or more exemplary embodiments, a method of determining a reference layer data unit for inter-prediction, and a method of determining a reference layer data unit for intra-prediction may differ in the inter-layer video encoding apparatus 1400 and the inter-layer video decoding apparatus 1500. The method of determining a reference layer data unit for inter-prediction according to an exemplary embodiment is described below with reference to FIGS. 23 and 24. The method of determining a reference layer data unit for intra-prediction according to another exemplary embodiment is described below with reference to FIGS. 25 and 26.

The inter-layer video encoding apparatus 1400 and the inter-layer video decoding apparatus 1500 according to one or more exemplary embodiments may determine motion information of a current block of an enhancement layer image by referring to motion information of at least one of a spatial candidate block and a temporal candidate block of the enhancement layer image, and a collocated block of a base layer image. After a motion candidate list including the spatial candidate block and the temporal candidate block of the enhancement layer image, and the collocated block of the base layer image is determined, an optimal reference block from among blocks that are included in the candidate list may be determined.

In a merge mode, prediction information of the reference block may be changelessly used as the motion information of the current block. However, the reference block may be determined only when a candidate list index indicating the reference block from among the blocks included in the candidate list is known. Thus, when the inter-layer video encoding apparatus 1400 according to one or more exemplary embodiments encodes the enhancement layer image in the merge mode, the inter-layer video encoding apparatus 1400 may not output motion information of an inter-block but may output the candidate list index. When the inter-layer video decoding apparatus 1500 according to one or more exemplary embodiments decodes the enhancement layer image in the merge mode, the inter-layer video decoding apparatus 1500 may not obtain the motion information of the inter-block but may obtain the candidate list index.

During a non-merge mode, for example, during an Adaptive Motion Vector Prediction (AMVP) mode, the motion information of the current block may be predicted by using the prediction information of the reference block. Thus, information about a motion vector difference between final motion information of the current block and the prediction information of the reference block may be determined. In this case, the reference block may be determined only when a candidate list index is known. Thus, when the inter-layer video encoding apparatus 1400 according to one or more exemplary embodiments encodes the enhancement layer image during the AMVP mode, the inter-layer video encoding apparatus 1400 may output motion vector difference information and a candidate list index of the inter-block. When the inter-layer video decoding apparatus 1500 according to one or more exemplary embodiments decodes the enhancement layer image during the AMVP mode, the inter-layer video decoding apparatus 1500 may parse the motion vector difference information and the candidate list index for the inter-block.

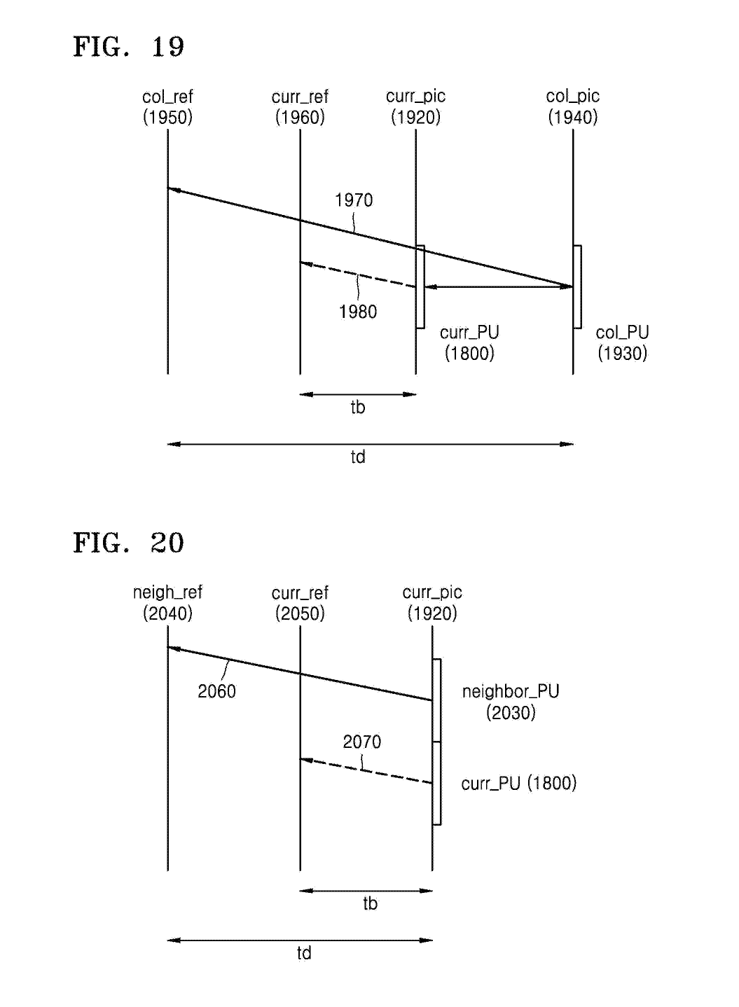

FIGS. 18 and 19 illustrate spatial candidate blocks in a same layer image and temporal candidate blocks that are included in a motion candidate list used to determine prediction information of an enhancement layer block during the merge mode. FIG. 20 illustrates spatial candidate blocks in a same layer image that are included in a motion candidate list used to determine the prediction information of the enhancement layer block during the AMVP mode.

FIG. 18 illustrates positions of the spatial candidate blocks for merging a plurality of pieces of prediction information, according to an exemplary embodiment.

Candidate blocks in a current picture 1920 to be referred to when determining prediction information of a current prediction unit 1800 may be prediction units that are spatially adjacent to the current prediction unit 1800. For example, a prediction unit A0 1810 that is positioned outside a lower left corner of a lower left sample of the current prediction unit 1800, a prediction unit A1 1820 that is positioned outside a left end of the lower left sample of the current prediction unit 1800, a prediction unit B0 1830 that is positioned outside an upper right corner of an upper right sample of the current prediction unit 1800, a prediction unit B1 1840 that is positioned outside an uppermost end of the upper right sample of the current prediction unit 1800, and a prediction unit B2 1850 that is positioned outside an upper left corner of an upper left sample of the current prediction unit 1800 may be the candidate blocks. In order to determine a block to become the candidate block, the prediction units 1810, 1820, 1830, 1840, and 1850 at predetermined positions may be examined in an order of the prediction units A1 1820, B1 1840, B0 1830, A0 1810, and B2 1850.

For example, four prediction units from among the prediction units A1 1820, B1 1840, B0 1830, A0 1810, and B2 1850 may be selected as the spatial candidate blocks. The four spatial candidate blocks may be included in a motion candidate list.

FIG. 19 illustrates positions of temporal candidate blocks and a scaling method, according to an exemplary embodiment.

From among prediction units of a candidate picture col_pic 1940 for merging a plurality of pieces of prediction information for a current prediction unit curr_PU 1800, a prediction unit col_PU 1930 of a current picture 1920 at a position corresponding to a position of the current prediction unit 1800 may be a collocated prediction unit of the current prediction unit 1800, and may be selected as a candidate block for the current prediction unit 1800.

A motion vector 1970 of the collocated prediction unit 1930 indicates a spatial distance between the collocated prediction unit 1930 and a reference image col_ref 1950 of the collocated prediction unit 1930. Thus, in order to use the motion vector 1970 of the collocated prediction unit 1930 for the current prediction unit 1800, a size of the motion vector 1970 of the collocated prediction unit 1930 may be adjusted to match with a distance tb between the current prediction unit 1800 and a reference image curr_ref 1960 of the current prediction unit 1800.

For example, a motion vector 1980 of the current prediction unit 1800 may be determined so as to allow a ratio of a distance td between the collocated candidate picture 1940 and the reference image 1950 of the collocated prediction unit 1930 to the size of the motion vector 1970 of the collocated prediction unit 1930 to be equal to a ratio of the distance tb between the current prediction unit 1800 and the reference image 1960 to a size of the motion vector 1980 of the current prediction unit 1800. td and tb indicate temporal distances between pictures, and may be difference values of picture order counts (POCs).

Thus, by scaling the motion vector 1970 of the collocated prediction unit 1930 by a ratio of td to tb, the motion vector 1980 of the current prediction unit 1800 may be estimated.

In this manner, one temporal candidate block may be selected from two candidate blocks that are positioned in two different candidate images. The selected one temporal candidate block may be included in the motion candidate list.

The candidate blocks that were determined with reference to FIGS. 18 and 19 may be included in the motion candidate list in the merge mode. Also, for inter-layer video encoding and inter-layer video decoding according to one or more exemplary embodiments, a base layer candidate prediction unit may be added to the motion candidate list. Prediction information of a reference block determined from the motion candidate list may be selected as prediction information of the current prediction unit 1800.

Candidate blocks that are included in a motion candidate list in the AMVP mode may also include a spatial candidate block and a temporal candidate block. The spatial candidate block for the AMVP mode is described in detail with reference to FIG. 20.

FIG. 20 illustrates positions of spatial prediction candidates and a scaling method for predicting prediction information, according to an exemplary embodiment.

Positions of neighboring prediction units that may become the spatial candidate block during the AMVP mode may be equal to the positions of neighboring prediction units during the merge mode shown in FIG. 18. However, during the AMVP mode, if the neighboring prediction unit and reference images of the current prediction unit 1800 are not the same, a size of a motion vector of the neighboring prediction unit may be scaled, and a motion vector of the current prediction unit 1800 may be predicted by using the scaled motion vector.

For example, one candidate block may be determined from among left neighboring prediction units, and another candidate block may be determined from among upper neighboring prediction units. In order to determine a candidate block of the current prediction unit 1800 from among the left neighboring prediction units, the left neighboring prediction units are examined in an order of the prediction units A0 1810 and A1 1820, a scaled A0 1810, and a scaled A1 1820. In order to determine a candidate block of the current prediction unit 1800 from among the upper neighboring prediction units, the upper neighboring prediction units are examined in an order of the prediction units B0 1830, B1 1840, and B2 1850, a scaled B0 1830, a scaled B1 1840, and a scaled B2 1850.

In FIG. 20, during the AMVP mode, if the current prediction unit 1800 and reference images 2050 and 2040 of a neighboring prediction unit neigh_PU 2030 are not the same, a scaled neighboring prediction unit 2030 is used as shown in FIG. 20.

In order to use a motion vector 2060 of the neighboring prediction unit 2030 for the current prediction unit 1800, a size of the motion vector 2060 of the neighboring prediction unit 2030 may be adjusted to be adapted for a distance tb between the current prediction unit 1800 and the reference image curr_ref 2050 of the current prediction unit 1800.

For example, a motion vector 2070 of the current prediction unit 1800 may be determined so as to allow a ratio of a distance td between the current picture 1920 and the reference image 2040 of the neighboring prediction unit 2030 to the size of the motion vector 2060 of the neighboring prediction unit 2030 to be equal to a ratio of the distance tb between the current prediction unit 1800 and the reference image 2050 to a size of the motion vector 2070 of the current prediction unit 1800.

Thus, by scaling the motion vector 2060 of the neighboring prediction unit 2030 by a ratio of td to tb, the motion vector 2070 of the current prediction unit 1800 may be estimated.

In this manner, one spatial candidate block may be selected from among the left neighboring prediction units, and another spatial candidate block may be selected from among the upper neighboring prediction units. The selected two spatial candidate blocks may be included in the motion candidate list.

During the AMVP mode, a temporal candidate block may be determined in a same manner as the spatial candidate block during the merge mode. One temporal candidate block may be selected from among a plurality of temporal candidate blocks and may be included in the motion candidate list.

The spatial candidate block and the temporal candidate block determined with reference to FIG. 20 may be included in the motion candidate list during the AMVP mode. Also, for inter-layer video encoding and inter-layer video decoding according to one or more exemplary embodiments, a base layer candidate block may be added to the motion candidate list. Information about a difference between a motion vector of a reference block determined from the motion candidate list and a motion vector of the current prediction unit 1800 may be signaled.

Hereinafter, a method of performing inter-layer video encoding on prediction information, and a method of performing inter-layer video decoding on the prediction information, the methods respectively being performed by the inter-layer video encoding apparatus 1400 and the inter-layer video decoding apparatus 1500 according to one or more exemplary embodiments, will now be described in detail.

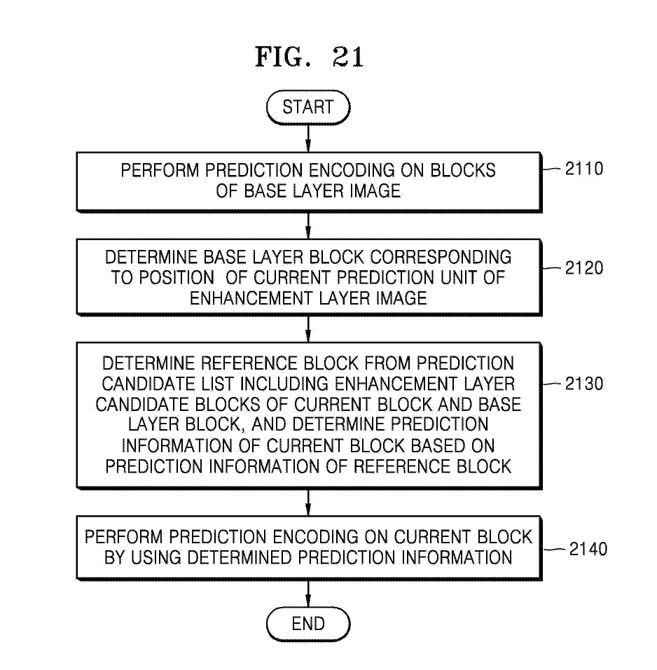

FIG. 21 is a flowchart of a method of performing inter-layer video encoding by using prediction information, according to one or more exemplary embodiments.

In operation 2110, the inter-layer video encoding apparatus 1400 according to one or more exemplary embodiments may perform prediction encoding on blocks of a base layer image. For example, the base layer image has a resolution lower than that of an enhancement layer image. The inter-layer video encoding apparatus 1400 may perform encoding on each of coding units of a tree structure that are obtained by splitting the base layer image, may perform prediction on a prediction unit split from the coding unit, and may perform transformation and quantization on a transformation unit split from the coding unit. Also, entropy encoding may be performed on each maximum coding unit.

In operation 2120, the inter-layer video encoding apparatus 1400 according to one or more exemplary embodiments may determine a base layer candidate prediction unit that is from among the blocks of the base layer image and corresponds to a position of a current prediction unit from among blocks of the enhancement layer image. Since the base layer image and the enhancement layer image have different resolutions, even if the base layer image and the enhancement layer image are split to lower level data units having the same structure, coordinates of a base layer prediction unit that corresponds to an enhancement layer prediction unit may be changed. Thus, a position of a prediction unit that corresponds to a current enhancement layer prediction unit may be examined from among base layer prediction units.

In operation 2130, the inter-layer video encoding apparatus 1400 according to one or more exemplary embodiments may determine a reference block for a current prediction unit from a prediction candidate list that includes one or more neighboring prediction units that are spatially adjacent to the current prediction unit, and the base layer candidate prediction unit. Based on prediction information of the reference block, prediction information of the current prediction unit may be determined.

The prediction candidate list according to one or more exemplary embodiments may include a spatial candidate prediction unit that is adjacent to the current prediction unit in a current enhancement layer image, and the base layer candidate prediction unit. The prediction candidate list for inter-prediction may further include a collocated prediction unit of another enhancement layer image.

In operation 2140, the inter-layer video encoding apparatus 1400 according to one or more exemplary embodiments may perform prediction encoding on the current prediction unit by using the prediction information. The inter-layer video encoding apparatus 1400 may perform encoding on each of coding units of a tree structure that are obtained by splitting the enhancement layer image, may perform prediction on a prediction unit split from the coding unit, and may perform transformation and quantization on a transformation unit split from the coding unit. Also, entropy encoding may be performed on each maximum coding unit.

As described above, the inter-layer video encoding apparatus 1400 according to one or more exemplary embodiments may determine a motion vector of the enhancement layer prediction unit in an inter-mode by referring to a motion vector of the base layer candidate prediction unit. A method of determining a position of a reference prediction unit so as to inter-layer predict a motion vector for the inter-prediction, and using the motion vector of the reference prediction unit of the base layer image will be described in detail with reference to FIG. 23.

As described above, the inter-layer video encoding apparatus 1400 according to another exemplary embodiment may determine an intra-index of the enhancement layer prediction unit in an intra-mode by referring to an intra-index of the base layer candidate prediction unit. A method of determining a position of the reference prediction unit so as to inter-layer predict the intra-index for intra-prediction, and using an intra-index of the reference prediction unit of the base layer image will be described in detail with reference to FIG. 25.

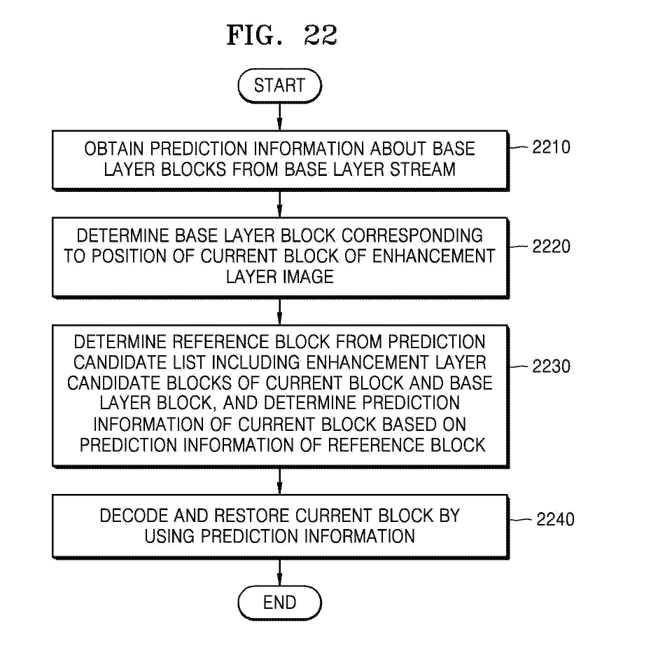

FIG. 22 is a flowchart of a method of performing inter-layer video decoding by using prediction information, according to one or more exemplary embodiments.

In operation 2210, the inter-layer video decoding apparatus 1500 according to one or more exemplary embodiments may obtain prediction information about blocks of a base layer image from a base layer stream. The inter-layer video decoding apparatus 1500 may perform entropy decoding on each of maximum coding units split from the base layer image, and may obtain encoding information of coding units of a tree structure. Inverse quantization and inverse transformation may be performed on each transformation unit, so that difference components may be restored. Motion compensation or intra-prediction may be performed on each of prediction units, according to a prediction mode, so that samples in a spatial domain may be restored.

In operation 2220, the inter-layer video decoding apparatus 1500 according to one or more exemplary embodiments may obtain encoding information of an enhancement layer image from an enhancement layer stream. However, information from among the encoding information of the enhancement layer image, which may be determined by using the encoding information of the base layer image, may not be obtained from the enhancement layer stream.

In operation 2230, the inter-layer video decoding apparatus 1500 according to one or more exemplary embodiments may determine a base layer candidate prediction unit that is from among prediction units of the base layer image and corresponds to a position of a current prediction unit from among prediction units of the enhancement layer image. In operation 2230, the inter-layer video decoding apparatus 1500 according to one or more exemplary embodiments may determine a reference prediction unit for the current prediction unit from a motion candidate list including one or more neighboring prediction units that are spatially adjacent to the current prediction unit, and the base layer candidate prediction unit. The inter-layer video decoding apparatus 1500 may determine prediction information of the current prediction unit, based on the prediction information of the reference prediction unit.

The inter-layer video decoding apparatus 1500 according to one or more exemplary embodiments may obtain, from the enhancement layer stream, a candidate list index that indicates the reference prediction unit from a prediction candidate list. The prediction information of the current prediction unit may be determined by using the prediction information of the reference prediction unit that is indicated by the candidate list index in the candidate list.

In operation 2240, the inter-layer video decoding apparatus 1500 according to one or more exemplary embodiments may perform decoding on the current prediction unit by using the prediction information, and may restore the current prediction unit.

As described above, the inter-layer video decoding apparatus 1500 according to an exemplary embodiment may determine a motion vector of an enhancement layer prediction unit in an inter-mode by referring to a motion vector of a base layer prediction unit. A method of determining a position of the reference prediction unit so as to inter-layer predict a motion vector for motion compensation, and using the motion vector of the reference prediction unit of the base layer image will be described in detail with reference to FIG. 24.

As described above, the inter-layer video decoding apparatus 1500 according to another exemplary embodiment may determine an intra-index for intra-prediction of the enhancement layer prediction unit in an intra-mode by referring to prediction information of the base layer prediction unit. A method of determining a position of the reference prediction unit so as to inter-layer predict the intra-index for the intra-prediction, and using an intra-index of the reference prediction unit of the base layer image will be described in detail with reference to FIG. 26.

FIG. 23 is a flowchart of an inter-layer video encoding method performed in an inter-mode, according to an exemplary embodiment.

In operation 2310, the inter-layer video encoding apparatus 1400 according to an exemplary embodiment may perform inter-prediction on prediction units of a base layer image and may generate prediction information including a motion vector, a prediction direction, and a reference index, and residue information.

In operation 2320, the inter-layer video encoding apparatus 1400 according to an exemplary embodiment may determine a base layer candidate prediction unit that is from among prediction units of a base layer image and is located at a position corresponding to a position of a current prediction unit from among prediction units of an enhancement layer image. The inter-layer video encoding apparatus 1400 according to an exemplary embodiment may determine prediction information of the current prediction unit by using prediction information of a reference prediction unit that is determined from among candidate blocks including the base layer candidate prediction unit.

In operation 2330, the inter-layer video encoding apparatus 1400 according to an exemplary embodiment may perform inter-prediction on the current prediction unit by using the prediction information and may generate residue information of the current prediction unit.

In operation 2340, the inter-layer video encoding apparatus 1400 according to an exemplary embodiment may generate information indicating that prediction of a motion vector is possible, in a current slice, between the base layer image and the enhancement layer image, i.e., may generate a slice header including inter-layer prediction mode information.

In operation 2320, an operation of determining a prediction unit of the base layer image that corresponds to a prediction unit of the enhancement layer image will now be described in detail. For convenience of description, it is assumed that the prediction unit of the enhancement layer image is called a ‘current prediction unit’, and the prediction unit of the base layer image that is located at a position corresponding to a position of the current prediction unit is called a ‘reference layer prediction unit’.

In order to determine coordinates of the reference layer prediction unit that correspond to coordinates of the current prediction unit, a position of a center pixel of the current prediction unit may be used. As another example, a position of an upper left pixel of the current prediction unit may be used. As another example, a position of a lower right pixel that is positioned outside in a diagonal direction of the current prediction unit may be used.

Various examples in which the coordinates of the reference layer prediction unit are determined are described below.

According to a first example, the coordinates that indicates a position of the current prediction unit may be converted to coordinates in the base layer image, based on a size ratio of the base layer image to the enhancement layer image. The converted coordinates are reduced through a bit-shift operation and are restored by being enlarged again through the bit-shift operation again, so that base layer coordinates may be compressed. By using the compressed base layer coordinates, a position of the reference layer prediction unit that corresponds to the current prediction unit may be determined.

For example, coordinates (xP, yP) of the current prediction unit indicate an x-axis distance and a y-axis distance between an upper left pixel of the enhancement layer image and an upper left sample of the current prediction unit. If a width and height of a current luma prediction unit are nPbW and nPbH, respectively, center coordinates (xPCtr, yPCtr) of the current prediction unit may be determined by using the following Equations.

xPCtr=xP+(nPbW>>1)

yPCtr=yP+(nPbH>>1)

For example, if a size of the current prediction unit is 16×16, the center coordinates (xPCtr, yPCtr) may be determined as (xP+8, yP+8).

The coordinates of the reference layer prediction unit that are obtained by scaling and converting the coordinates (xP, yP) of the current prediction unit according to a resolution of the base layer image may be determined as (xRef, yRef). For example, the coordinates of the current prediction unit may correspond to coordinates of a sub-pixel with an 1/16-accuracy in comparison with a prediction accuracy of the reference layer prediction unit. The coordinates (xRef, yRef) of the reference layer prediction unit indicate an x-axis distance and a y-axis distance between an upper left pixel of the base layer image and an upper left sample of the reference layer prediction unit.

Compressed coordinates that are obtained by reducing and enlarging, through a bit-shift operation, the coordinates (xRef, yRef) of the reference layer prediction unit that correspond to the current prediction unit may be determined as coordinates of the reference layer prediction unit at a position corresponding to a position of the current prediction unit. For example, coordinates (xRL, yRL) of the reference layer prediction unit that are collocated coordinates corresponding to the center coordinates (xPCtr, yPCtr) of the current prediction unit may be determined by using the following Equations.

xRL=((xRef+8)>>4)<<4

yRL=((yRef+8)>>4)<<4

Thus, by referring to a prediction mode, motion information, etc. that are allocated to the reference layer prediction unit at a position of the coordinates (xRL, yRL) in the base layer image, motion information of the current prediction unit may be predicted.

According to a second example, the position of the reference layer prediction unit may be determined by using compressed coordinates of the current prediction unit. The center coordinates (xPCtr, yPCtr) of the current prediction unit may be changed to compressed coordinates ((xPCtr>>4)<<4, (yPCtr>>4)<<4). A prediction unit of the base layer image that includes coordinates of the base layer image that correspond to the compressed center coordinates of the current prediction unit may be determined as the reference layer prediction unit.

According to a third example, coordinates (xPRb, yPRb) of a lower right sample outside the current prediction unit may be changed to compressed coordinates ((xPRb>>4)<<4, (yPRb>>4)<<4).

A prediction unit of the base layer image that includes coordinates of the base layer image that correspond to the compressed coordinates of the current prediction unit may be determined as the reference layer prediction unit. However, in this case, if a y-axis coordinate value yP of the upper left sample and a y-axis coordinate value yPRb of the lower right sample outside the current prediction unit do not belong to a same maximum coding unit, they may be set as being non-referable with respect to the reference layer prediction unit.

In operation 2320, from a motion candidate list that includes the reference layer prediction unit determined according to the aforementioned various examples, and the spatial candidate prediction unit and the temporal candidate prediction unit described above with reference to at least one of FIGS. 18, 19, and 20, a reference block to be referred to in prediction of motion information may be determined. In a case where a limited number of candidate prediction units are allowed, if a total number of the spatial candidate prediction unit and the temporal candidate prediction unit exceed the limited number, the temporal candidate prediction unit may be removed from the motion candidate list.

In order to determine the reference block from candidate prediction units included in the motion candidate list, motion information of the current prediction unit may be determined by using a motion vector of the candidate prediction units. The candidate prediction unit having motion information of a highest prediction efficiency may be determined as the reference block.

If it is possible to add the reference layer prediction unit to the motion candidate list, a motion vector of the reference layer prediction unit may be added to the motion candidate list, according to one or more exemplary embodiments. Motion information of the base layer candidate prediction unit may be scaled based on a size ratio of the base layer image to the enhancement layer image, and the scaled motion information may be added as motion information of the reference layer prediction unit to the motion candidate list.

For example, the scaled motion information of the reference layer prediction unit may be added as a last block of candidate blocks that are included in the motion candidate list. As another example, the scaled motion information of the reference layer prediction unit may be added as a first block of the candidate blocks that are included in the motion candidate list.

A position in the motion candidate list to which the scaled motion information of the reference layer prediction unit is added may be determined for each sequence. In this case, information about where the scaled motion information of the reference layer prediction unit is added in the motion candidate list may be included in an SPS.

As another example, the position in the motion candidate list to which the scaled motion information of the reference layer prediction unit is added may be determined for each picture. In this case, the information about where the scaled motion information of the reference layer prediction unit is added in the motion candidate list may be included in a PPS.

As another example, the position in the motion candidate list to which the scaled motion information of the reference layer prediction unit is added may be determined for each slice. In this case, the information about where the scaled motion information of the reference layer prediction unit is added in the motion candidate list may be included in a slice header.

As another example, the information about where the scaled motion information of the reference layer prediction unit is added in the motion candidate list may not be separately signaled, but the information about an added position in the motion candidate list may be determined based on a distance between a current picture and a reference picture.

As in the aforementioned various examples, the motion candidate list may additionally include the reference layer prediction unit as well as the spatial candidate prediction unit or the temporal candidate prediction unit that belongs to the enhancement layer image.

If the spatial candidate prediction unit or the temporal candidate prediction unit is not referable, the reference layer prediction unit may be included in the motion candidate list, instead of the non-inferable prediction unit. In more detail, if a neighboring prediction unit that is located as the temporal candidate prediction unit at a lower right position outside the current prediction unit is not referable, the reference layer prediction unit may be included in the motion candidate list.

However, before the reference layer prediction unit is included in the motion candidate list, the inter-layer video encoding apparatus 1400 according to an exemplary embodiment may pre-examine whether the scaled motion information of the reference layer prediction unit overlaps with another candidate motion information that is already included in the motion candidate list. If overlapping candidate motion information does not exist, the reference layer prediction unit may be included in the motion candidate list.

According to the aforementioned various examples, the motion information of the current prediction unit may be determined by using the motion information of the reference block that is determined from the motion candidate list including the reference layer prediction unit.

FIG. 24 is a flowchart of an inter-layer video decoding method performed in an inter-mode, according to an exemplary embodiment.

In operation 2410, the inter-layer video decoding apparatus 1500 according to an exemplary embodiment may obtain, from a base layer stream, prediction information including a motion vector, a prediction direction, and a reference index, and residue information of prediction units of a base layer image.

In operation 2420, the inter-layer video decoding apparatus 1500 according to an exemplary embodiment may obtain, from a slice header of an enhancement layer stream, information indicating that motion vector prediction is possible between the base layer image and an enhancement layer image.

In operation 2430, the inter-layer video decoding apparatus 1500 according to an exemplary embodiment may determine a reference layer prediction unit that is from among prediction units of the base layer image and corresponds to a position of a current prediction unit from among prediction units of the enhancement layer image. Prediction information of the current prediction unit may be determined by using prediction information of a reference block that is determined from among candidate prediction units including the reference layer prediction unit.

The inter-layer video decoding apparatus 1500 according to an exemplary embodiment may obtain index information of a motion candidate list, and may determine the reference block that is indicated by the index information from among the candidate prediction units of the motion candidate list.

In operation 2430, various examples for determining a position of the reference layer prediction unit that corresponds to the current prediction unit are described above with reference to FIG. 23. Also, various examples in which the scaled motion information of the reference layer prediction unit is added to the motion candidate list are described above with reference to FIG. 23.

In operation 2440, the inter-layer video decoding apparatus 1500 according to an exemplary embodiment may perform motion compensation on the current prediction unit by using the prediction information and residue information of the current prediction unit that is obtained from the enhancement layer stream, and thus, may restore the current prediction unit.

FIG. 25 is a flowchart of an inter-layer video encoding method performed in an intra-mode, according to another exemplary embodiment.

In operation 2510, the inter-layer video encoding apparatus 1400 according to an exemplary embodiment may perform intra-prediction on prediction units of a base layer image, and thus may generate intra-index information for each of the prediction units.

In operation 2520, the inter-layer video encoding apparatus 1400 according to an exemplary embodiment may determine a reference layer prediction unit that is from among the prediction units of the base layer image and corresponds to a position of a current prediction unit from among prediction units of an enhancement layer image. The inter-layer video encoding apparatus 1400 according to an exemplary embodiment may determine an intra-index of the current prediction unit, based on uniformity between intra-indexes of two or more prediction units that are spatially adjacent to the current prediction unit, and an intra-index of a base layer prediction unit.

In operation 2530, the inter-layer video encoding apparatus 1400 according to an exemplary embodiment may perform intra-prediction on the current prediction unit by using the intra-index determined in operation 2520.

In operation 2520, candidate prediction units to be referred to in prediction of intra information of the current prediction unit may include the two or more prediction units that are spatially adjacent. For example, the intra-index of the current prediction unit may be determined, in consideration of intra-indexes of a left neighboring prediction unit and an upper neighboring prediction unit from among the prediction units that are spatially adjacent to the current prediction unit in the enhancement layer image.

The inter-layer video encoding apparatus 1400 according to an exemplary embodiment may determine the intra-index of the current prediction unit, in consideration of not only the spatially-adjacent prediction units but also in consideration of an intra-index of the reference layer prediction unit.

For example, if the left neighboring prediction unit, the upper neighboring prediction unit, and the reference layer prediction unit use a common intra-index, a first candidate intra-index may be determined as the common intra-index, and a second candidate intra-index and a third candidate intra-index may be determined as predetermined intra-indexes, respectively. One of the three candidate intra-indexes may be selected and may be determined as a current intra-index.

If at least one pair of prediction units from among the left neighboring prediction unit, the upper neighboring prediction unit and the reference layer prediction unit uses a common intra-index, a first candidate intra-index and a second candidate intra-index may be determined as two different intra-indexes that are used by the left neighboring prediction unit, and the upper neighboring prediction unit and the reference layer prediction unit. That is, the common intra-index used by the one pair of prediction units may be determined as the first candidate intra-index, and an intra-index used by the residual prediction unit may be determined as the second candidate intra-index. A third candidate intra-index may be determined as a predetermined intra-index.

For example, if all of the left neighboring prediction unit, the upper neighboring prediction unit, and the reference layer prediction unit use different intra-indexes, first, second, and third candidate intra-indexes may be determined as the intra-indexes of the left neighboring prediction unit, the upper neighboring prediction unit, and the reference layer prediction unit.

The first, second, and third candidate intra-indexes may be sorted in an ascending order.

In more detail, an intra-index 0 indicates a planar mode, and an intra-index 1 indicates a DC mode. In addition to the intra-indexes 0 and 1, 32 directional intra-indexes may be set.

If the left neighboring prediction unit and the upper neighboring prediction unit of the current prediction unit, and the base layer prediction unit have a common intra-index, and the common intra-index is an intra-index 0 or 1, the first, second, and third candidate intra-indexes of the current prediction unit may be set to indicate the planar mode, the DC mode, and a vertical mode, respectively.

However, if the common intra-index is neither the intra-index 0 nor 1, the first candidate intra-index may be determined as an intra-index IntraPredModeA of the left neighboring prediction unit. Each of the second candidate intra-index and the third candidate intra-index may be determined based on the intra-index IntraPredModeA of the left neighboring prediction unit. The second and third candidate intra-indexes may be set as sequentially preceding and following intra-indexes of the first candidate intra-index. For example, the second candidate intra-index may be determined by using Equation ‘2+((candIntraPredModeA+29) % 32)’, and the third candidate intra-index may be determined by using Equation ‘2+((candIntraPredModeA−2+1) % 32)’.

If two prediction units from among the left neighboring prediction unit and the upper neighboring prediction unit of the current prediction unit and the base layer prediction unit have a common intra-index, a first candidate intra-index may be determined as the common intra-index of the two prediction units, and a second candidate intra-index may be determined as an intra-index of the residual prediction unit other than the two prediction units.

In this case, a third candidate intra-index may be determined as a predetermined intra-index. For example, if any one of the first and second candidate intra-indexes does not indicate the planar mode, the third candidate intra-index may be determined to indicate the planar mode. As another example, if any one of the first and second candidate intra-indexes does not indicate the DC mode, the third candidate intra-index may be determined to indicate the DC mode. As another example, the third candidate intra-index may be determined to indicate the vertical mode.

If the left neighboring prediction unit, the upper neighboring prediction unit, and the base layer prediction unit are all different, the first, second, and third candidate intra-indexes of the current prediction unit may be determined as an intra-index of the left neighboring prediction unit, an intra-index of the upper neighboring prediction unit, and an intra-index of the base layer prediction unit, respectively. As another example, the first, second, and third candidate intra-indexes of the current prediction unit may be determined as an intra-index of the base layer prediction unit, an intra-index of the left neighboring prediction unit, and an intra-index of the upper neighboring prediction unit, respectively.

In operation 2520, a method of determining a position of the reference layer prediction unit that corresponds to the current prediction unit is similar to that described with reference to FIG. 23. That is, in order to determine coordinates of the reference layer prediction unit that correspond to coordinate of the current prediction unit, a position of a center pixel of the current prediction unit may be used. As another example, a position of an upper left pixel of the current prediction unit may be used. As another example, a position of a lower right pixel that is positioned outside in a diagonal direction of the current prediction unit may be used.

FIG. 26 is a flowchart of an inter-layer video decoding method performed in an intra-mode, according to another exemplary embodiment.

In operation 2610, the inter-layer video decoding apparatus 1500 according to an exemplary embodiment may obtain, from a base layer stream, intra-indexes of prediction units of a base layer image.

In operation 2620, the inter-layer video decoding apparatus 1500 according to an exemplary embodiment may determine a base layer prediction unit that is from among the prediction units of the base layer image and corresponds to a position of a current prediction unit from among prediction units of an enhancement layer image. The inter-layer video decoding apparatus 1500 according to an exemplary embodiment may determine an intra-index of the current prediction unit, based on uniformity between intra-indexes of two or more prediction units that are spatially adjacent to the current prediction unit, and an intra-index of a base layer prediction unit.

The inter-layer video decoding apparatus 1500 according to an exemplary embodiment may obtain, from an enhancement layer stream, information indicating a reference intra-index for the current prediction unit in an intra-mode, and thus, may select the reference intra-index from among candidate intra-indexes.

In operation 2620, various examples of determining a position of a reference layer prediction unit that corresponds to the current prediction unit are described above with reference to FIG. 23. Also, various examples in which an intra-index of the layer prediction unit along with intra-indexes of left and upper neighboring prediction units are used as candidate intra-indexes are described above with reference to FIG. 25.

In operation 2630, the inter-layer video decoding apparatus 1500 according to an exemplary embodiment may perform intra-prediction on the current prediction unit by using the determined intra-index of the current prediction unit, and thus may restore the current prediction unit.

In order to inter-layer predict prediction information, the inter-layer video encoding apparatus 1400 and the inter-layer video decoding apparatus 1500 according to the one or more exemplary embodiments may use the base layer prediction unit as a candidate block in the merge mode or the AMVP mode. Accordingly, the prediction information of the prediction unit of the enhancement layer image may be determined, in consideration of not only spatial/temporal neighboring prediction units of the enhancement layer image but also in consideration of the prediction information of the collocated prediction unit of the base layer image, so that intra-layer prediction or inter-layer prediction may be selectively performed on the coding units of the tree structure.

In each of the coding units, decoding is performed on a maximum coding unit so that image data in a spatial domain may be restored, and a video that is formed of pictures and pictures sequences may be restored. The restored video may be reproduced by a reproducing apparatus, may be stored in a storage medium, or may be transmitted via a network.

The inter-layer video encoding methods according to the one or more exemplary embodiments described with reference to FIGS. 21, 23, and 25 correspond to operations by the inter-layer video encoding apparatus 1400 for prediction information. The inter-layer video encoding apparatus 1400 according to the one or more exemplary embodiments may include a memory having recorded thereon a program for executing, by using a computer, the inter-layer video encoding methods using the prediction information described with reference to FIGS. 21, 23, and 25, may retrieve and execute the program from the memory, and thus may perform operations of the inter-layer video encoding apparatus 1400 which are described above with reference to FIG. 14. Alternatively, the inter-layer video encoding apparatus 1400 may read and execute a program from a recording medium having recorded thereon the program for executing the inter-layer video encoding methods, by using a computer, so that the inter-layer video encoding apparatus 1400 may perform operations of the inter-layer video encoding apparatus 1400 which are described above with reference to FIG. 14.

The inter-layer video decoding methods using the prediction information described with reference to FIGS. 22, 24, and 26 correspond to operations by the inter-layer video decoding apparatus 1500. The inter-layer video decoding apparatus 1500 may include a memory having recorded thereon a program for executing, by using a computer, the inter-layer video decoding methods described with reference to FIGS. 22, 24, and 26, may retrieve and execute the program from the memory, and thus may perform operations of the inter-layer video decoding apparatus 1500 which are described above with reference to FIG. 15. Also, the inter-layer video decoding apparatus 1500 may read and execute the program from a recording medium having recorded thereon a program for executing the inter-layer video decoding methods, by using a computer, so that the inter-layer video decoding apparatus 1500 may perform operations of the inter-layer video decoding apparatus 1500 which are described above with reference to FIG. 15.

For convenience of description, the inter-layer video encoding methods, or the video encoding method according to the inter-layer video encoding methods, which are described with reference to FIGS. 1 through 26, will be collectively referred to as ‘the video encoding method according to an exemplary embodiment’. Also, the inter-layer video decoding methods or the video decoding method according to the inter-layer video decoding methods, which are described with reference to FIGS. 1 through 26, will be collectively referred to as ‘the video decoding method according to an exemplary embodiment’.

Also, a video encoding apparatus including an inter-layer video encoding apparatus 10 for prediction information, the video encoding apparatus 100, or the image encoder 400, which is described with reference to FIGS. 1 through 26, will be collectively referred as a ‘video encoding apparatus according to an exemplary embodiment’. Also, a video decoding apparatus including an inter-layer video encoding apparatus 20 for prediction information, the video decoding apparatus 200, or the image decoder 500, which is described with reference to FIGS. 1 through 26, will be referred to as a ‘video decoding apparatus according to an exemplary embodiment’.

A computer-readable recording medium storing a program, e.g., a disc 26000, according to an exemplary embodiment will now be described in detail.

FIG. 27 is a diagram of a physical structure of the disc 26000 in which a program is stored, according to an exemplary embodiment. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantized parameter determining method, the video encoding method, and the video decoding method described above may be assigned and stored.

A computer system embodied using a storage medium that stores a program for executing the video encoding method and the video decoding method as described above will now be described with reference to FIG. 28.

FIG. 28 is a diagram of a disc drive 26800 for recording and reading a program by using the disc 26000. A computer system 26700 may store a program that executes at least one of a video encoding method and a video decoding method according to an exemplary embodiment, in the disc 26000 via the disc drive 26800. To run the program stored in the disc 26000 in the computer system 26700, the program may be read from the disc 26000 and be transmitted to the computer system 26700 by using the disc drive 26800.

The program that executes at least one of a video encoding method and a video decoding method according to an exemplary embodiment may be stored not only in the disc 26000 illustrated in FIGS. 27 and 28 but also may be stored in a memory card, a ROM cassette, or a solid state drive (SSD).

A system to which the video encoding method and a video decoding method described above are applied will be described below.

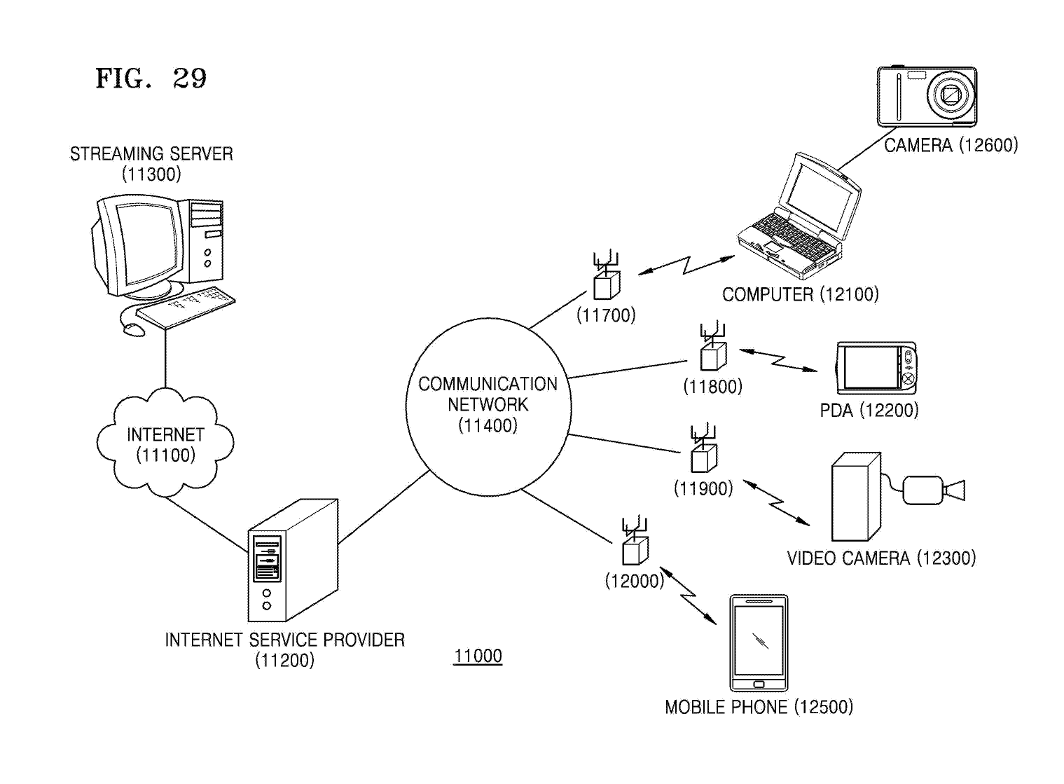

FIG. 29 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 29, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to an exemplary embodiment.

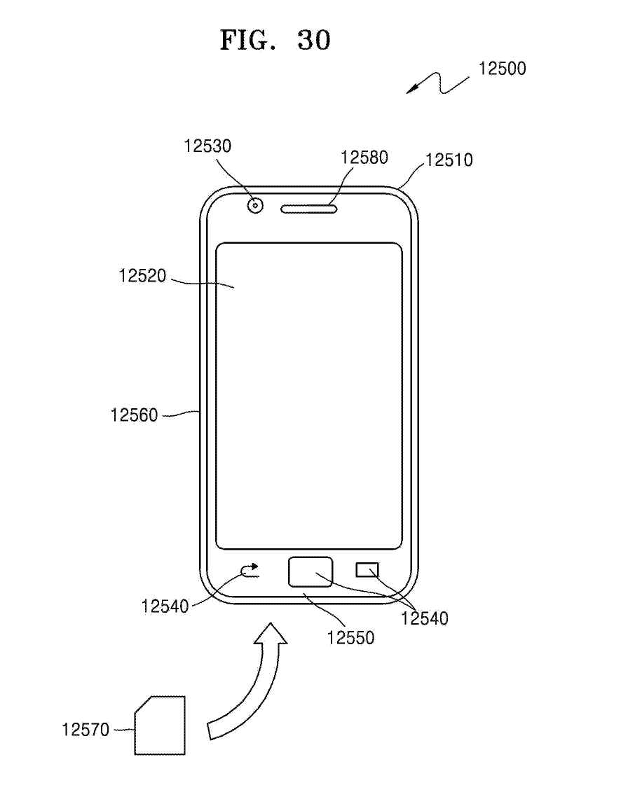

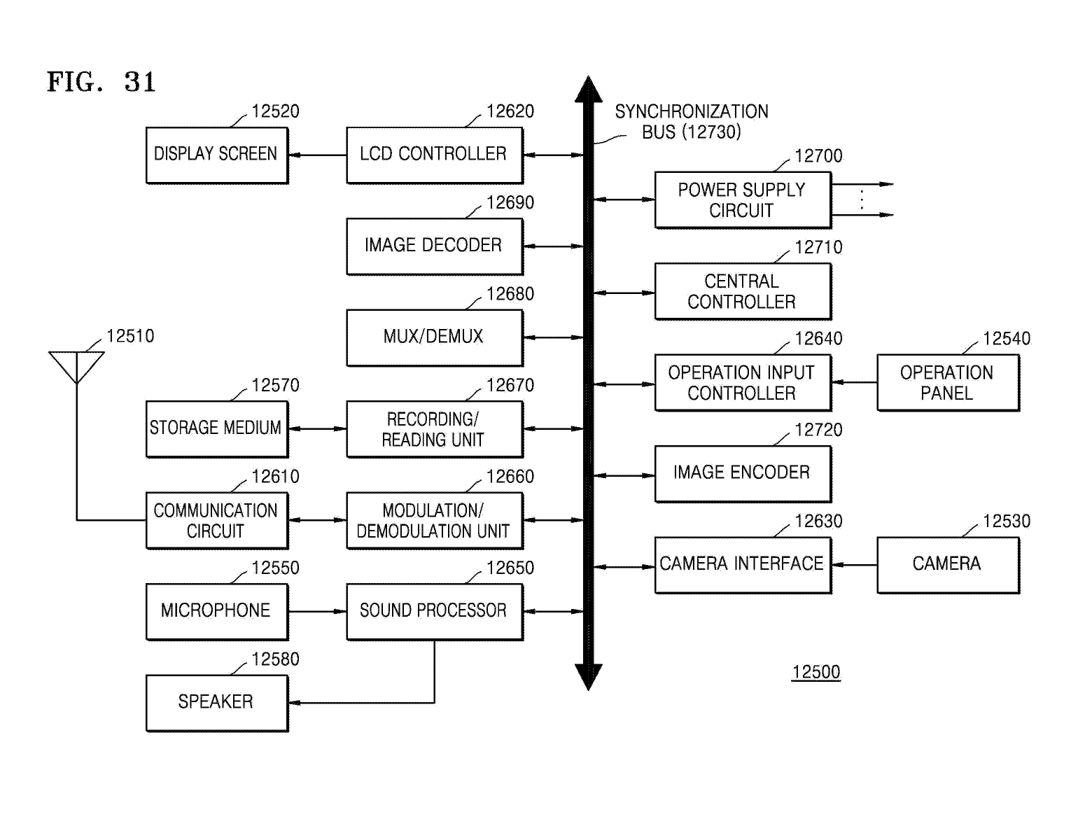

The mobile phone 12500 included in the content supply system 11000 according to an exemplary embodiment will now be described in greater detail with referring to FIGS. 30 and 31.

FIG. 30 illustrates an external structure of the mobile phone 12500 to which a video encoding method and a video decoding method are applied, according to an exemplary embodiment. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 31 illustrates an internal structure of the mobile phone 12500, according to an exemplary embodiment. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a power on’ state, the power supply circuit 12700 supplies power to all the parts of the mobile phone 12500 from a battery pack, thereby setting the mobile phone 12500 during an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted during a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

To transmit image data during the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus 100 described above. The image encoder 12720 may transform the image data received from the camera 12530 into compressed and encoded image data according to the aforementioned video encoding method according to an exemplary embodiment, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoder 12690, the sound processor 12650, or the LCD controller 12620, according to the type of the digital signal.

During the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When during the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoder 12690 and the sound processor 12650, respectively.

A structure of the image decoder 12690 may correspond to that of the video decoding apparatus described above. The image decoder 12690 may decode the encoded video data to obtain restored video data and provide the restored video data to the display screen 12520 via the LCD controller 12620, by using the aforementioned video decoding method according to an exemplary embodiment.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an exemplary embodiment, may be a transceiving terminal including only the video encoding apparatus, or may be a transceiving terminal including only the video decoding apparatus.

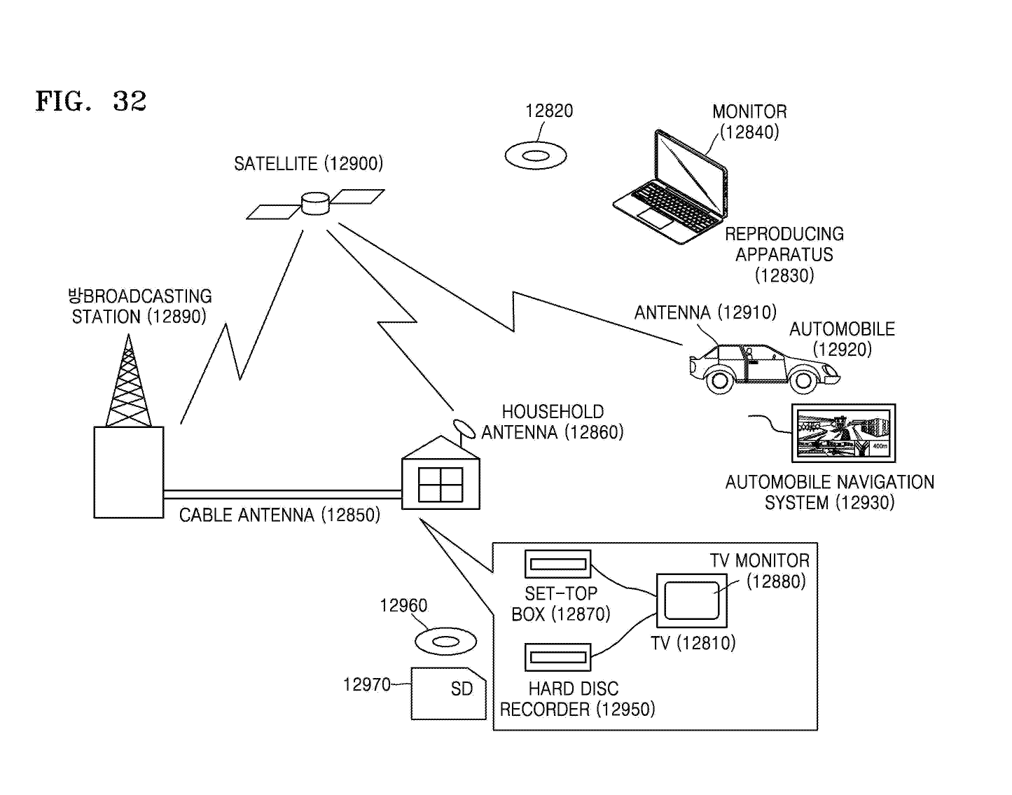

A communication system according to an exemplary embodiment is not limited to the communication system described above with reference to FIG. 30. For example, FIG. 32 illustrates a digital broadcasting system employing a communication system, according to an exemplary embodiment. The digital broadcasting system of FIG. 32 may receive a digital broadcast transmitted via a satellite or a terrestrial network by using a video encoding apparatus and a video decoding apparatus according to an exemplary embodiment.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to an exemplary embodiment is implemented in a reproducing apparatus 12830, the reproducing apparatus 12830 may parse and decode an encoded video stream recorded on a storage medium 12820, such as a disc or a memory card to restore digital signals. Thus, the restored video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to an exemplary embodiment may be installed. Data output from the set-top box 12870 may also be reproduced on a TV monitor 12880.

As another example, a video decoding apparatus according to an exemplary embodiment may be installed in the TV receiver 12810 instead of the set-top box 12870.

An automobile 12920 that has an appropriate antenna 12910 may receive a signal transmitted from the satellite 12900 or the wireless base station 11700 of FIG. 21. A decoded video may be reproduced on a display screen of an automobile navigation system 12930 installed in the automobile 12920.

A video signal may be encoded by a video encoding apparatus according to an exemplary embodiment and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to an exemplary embodiment, a video signal recorded on the DVD disc 12960, the SD card 12970, or another storage medium may be reproduced on the TV monitor 12880.

The automobile navigation system 12930 may not include the camera 12530, the camera interface 12630, and the image encoder 12720 of FIG. 26. For example, the computer 12100 and the TV receiver 12810 may not be included in the camera 12530, the camera interface 12630, and the image encoder 12720 of FIG. 26.

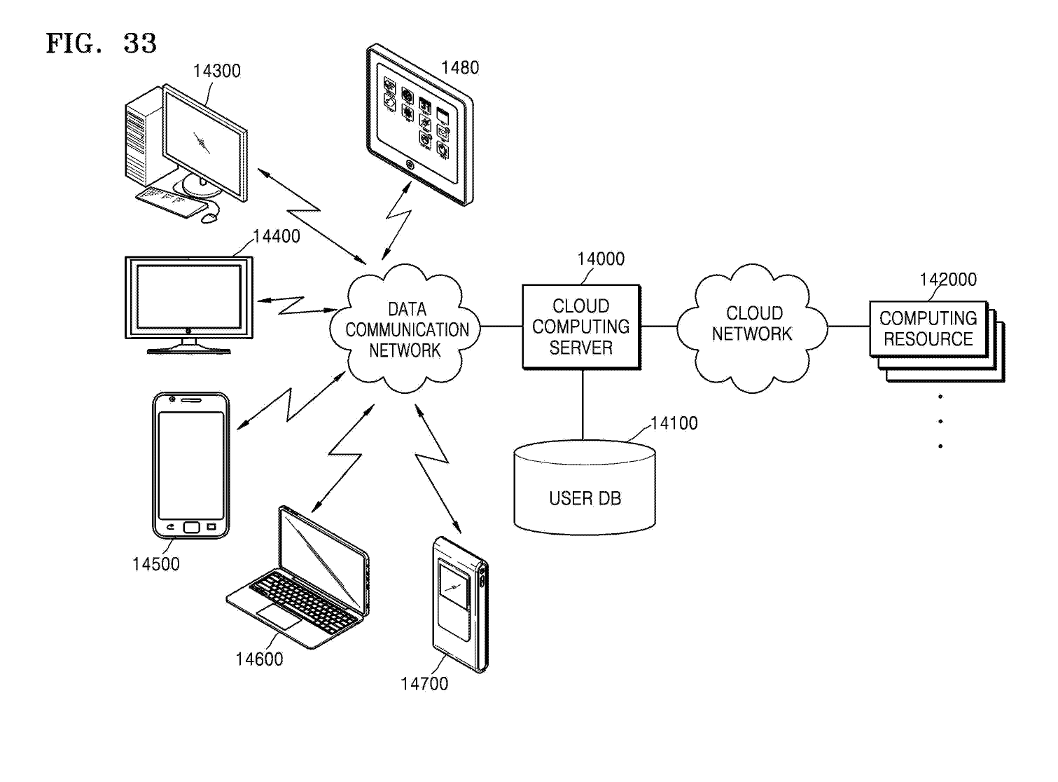

FIG. 33 is a diagram illustrating a network structure of a cloud computing system using a video encoding apparatus and a video decoding apparatus, according to an exemplary embodiment.

The cloud computing system may include a cloud computing server 14000, a user database (DB) 14100, a plurality of computing resources 142000, and a user terminal.

The cloud computing system provides an on-demand outsourcing service of the plurality of computing resources 142000 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security software, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 1480, and the like.

The cloud computing server 14000 may combine the plurality of computing resources 142000 distributed in a cloud network and provide user terminals with a result of combining. The plurality of computing resources 142000 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIGS. 30 and 31.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1 through 26. In another example, the user terminal may include a video encoding apparatus as described above with reference to FIGS. 1 through 26. Alternatively, the user terminal may include both the video decoding apparatus and the video encoding apparatus as described above with reference to FIGS. 1 through 26.

Various applications of a video encoding method, a video decoding method, a video encoding apparatus, and a video decoding apparatus according to exemplary embodiments described above with reference to FIGS. 1 through 26 are described above with reference to FIGS. 27 through 33. However, methods of storing the video encoding method and the video decoding method in a storage medium or methods of implementing the video encoding apparatus and the video decoding apparatus in a device described above with reference to FIGS. 1 through 26, according to various exemplary embodiments, are not limited to the exemplary embodiments described above with reference to FIGS. 27 through 33.

While exemplary embodiments have been particularly shown and described with reference to drawings thereof, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the exemplary embodiments is defined not by the detailed description but by the appended claims, and all differences within the scope will be construed as being included in the exemplary embodiments.

The exemplary embodiments can be written as computer programs and can be implemented in general-use or special purpose digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

1. An inter-layer video decoding method comprising:
obtaining, from a base layer stream, prediction information comprising a motion vector, a prediction direction, and a reference index, and residue information of blocks of a base layer image;
obtaining, from a slice header of an enhancement layer stream, information indicating that motion vector prediction is possible between the base layer image and an enhancement layer image;
determining a base layer candidate block that is from among the blocks of the base layer image and corresponds to a position of a current block from among blocks of the enhancement layer image, and determining prediction information of the current block by using prediction information of a reference block that is determined from among candidate blocks comprising the base layer candidate block; and
performing motion compensation on the current block by using the determined prediction information and residue information of the current block that is obtained from the enhancement layer stream, and thus, restoring the current block.

2. The inter-layer video decoding method of claim 1, wherein the determining of the prediction information comprises:
converting coordinates of the position of the current block in the enhancement layer image into coordinates in the base layer image, based on a size ratio of the base layer image to the enhancement layer image, reducing and restoring the coordinates through a bit-shift operation, and thus, compressing the coordinates; and
determining, by using the compressed coordinates, a position of the base layer candidate block that corresponds to the current block.

3. The inter-layer video decoding method of claim 1, wherein the determining of the prediction information comprises:
scaling a motion vector of the base layer candidate block, based on a size ratio of the base layer image to the enhancement layer image; and
determining a motion vector of the current block by using the scaled motion vector.

4. The inter-layer video decoding method of claim 1, wherein the determining of the prediction information comprises:
adding the base layer candidate block to a candidate list comprising candidate blocks comprising at least one selected from a spatial candidate block of the enhancement layer image and a temporal candidate block of another enhancement layer image;
determining the reference block of the current block from the candidate list by using a candidate list index obtained from the enhancement layer stream; and
determining the prediction information of the current block by using the prediction information of the reference block,
wherein a motion vector of the base layer candidate block is scaled based on a size ratio of the base layer image to the enhancement layer image, and the scaled motion vector is used in predicting the prediction information of the current block.

5. The inter-layer video decoding method of claim 4, further comprising, if a prediction mode of the prediction information of the current block is a merge mode, obtaining the residue information and the candidate list index from the enhancement layer stream, and
wherein the determining of the prediction information comprises determining the prediction information of the current block by using the motion vector, the prediction direction, and the reference index of the prediction information of the reference block.

6. The inter-layer video decoding method of claim 4, further comprising, if a prediction mode of the prediction information of the current block is not a merge mode, obtaining the residue information, the candidate list index, and a difference motion vector from the enhancement layer stream, and
wherein the determining of the prediction information comprises determining a motion vector of the current block by combining the motion vector with the difference motion vector of the prediction information of the reference block.

7. The inter-layer video decoding method of claim 1, wherein a resolution of the current block of the enhancement layer image is 16×16, and a resolution of the base layer image is 4×4.

8. The inter-layer video decoding method of claim 1, wherein the obtaining of the prediction information and the residue information comprises:
performing entropy decoding on the base layer stream, and obtaining the prediction information and the residue information of each of the blocks of the base layer image; and
performing motion compensation by using prediction information and residue information obtained for inter-prediction mode blocks of the base layer image, and thus, restoring the inter-prediction mode blocks,
wherein the obtaining of the information comprises obtaining residue information of each of the blocks of the enhancement layer image by performing entropy decoding on the enhancement layer stream, and
wherein the restoring of the current block comprises restoring the enhancement layer image by performing motion compensation by using prediction information determined for each of the blocks of the enhancement layer image, and the residue information of each of the blocks of the enhancement layer image obtained from the enhancement layer stream.

9. An inter-layer video encoding method comprising:
performing inter-prediction on blocks of a base layer image, and generating prediction information comprising a motion vector, a prediction direction, and a reference index, and residue information;
determining a base layer candidate block that is from among the blocks of the base layer image and corresponds to a position of a current block from among blocks of an enhancement layer image, and determining prediction information of the current block by using prediction information of a reference block that is determined from among candidate blocks comprising the base layer candidate block;
performing inter-prediction on the current block by using the determined prediction information, and generating residue information of the current block; and
generating a slice header comprising information indicating motion vector prediction is possible between the base layer image and the enhancement layer image.

10. The inter-layer video encoding method of claim 9, wherein the determining of the prediction information comprises:
converting coordinates of the position of the current block in the enhancement layer image into coordinates in the base layer image, based on a size ratio of the base layer image to the enhancement layer image, reducing and restoring the coordinates through a bit-shift operation, and thus, compressing the coordinates; and
determining, by using the compressed coordinates, a position of the base layer candidate block that corresponds to the current block.

11. The inter-layer video encoding method of claim 9, wherein the determining of the prediction information comprises:
scaling a motion vector of the base layer candidate block, based on a size ratio of the base layer image to the enhancement layer image; and
determining a motion vector of the current block by using the scaled motion vector.

12. The inter-layer video encoding method of claim 9, wherein the determining of the prediction information comprises:
adding the base layer candidate block to a candidate list comprising at least one selected from a spatial candidate block of the enhancement layer image and a temporal candidate block of another enhancement layer image;
comparing results of prediction that was performed on the prediction information of the current block by using a plurality of pieces of prediction information of candidate blocks comprised in the candidate list, and determining the reference block of the current block; and
determining the prediction information of the current block by using the prediction information of the reference block,
wherein a motion vector of the base layer candidate block is scaled based on a size ratio of the base layer image to the enhancement layer image, and the scaled motion vector is used in predicting the prediction information of the current block.

13. An inter-layer video decoding apparatus comprising:
a base layer decoder for obtaining, from a base layer stream, prediction information comprising a motion vector, a prediction direction, and a reference index, and residue information of blocks of a base layer image; and
an enhancement layer decoder for determining a base layer candidate block that is from among the blocks of the base layer image and corresponds to a position of a current block from among blocks of an enhancement layer image, for determining prediction information of the current block by using prediction information of the base layer candidate block, and for performing motion compensation on the current block by using the determined prediction information and residue information of the current block that is obtained from an enhancement layer stream, and thus, restoring the current block, and
wherein the enhancement layer decoder obtains, from a slice header of the enhancement layer stream, information indicating that motion vector prediction is possible between the base layer image and the enhancement layer image.

14. An inter-layer video encoding apparatus comprising:
a base layer encoder for performing inter-prediction on blocks of a base layer image, and generating prediction information comprising a motion vector, a prediction direction, and a reference index, and residue information; and
an enhancement layer encoder for determining a base layer candidate block that is from among the blocks of the base layer image and corresponds to a position of a current block from among blocks of an enhancement layer image, for determining prediction information of the current block by using prediction information of the base layer candidate block, and for generating residue information of the current block by performing inter-prediction on the current block by using the determined prediction information, and
wherein the enhancement layer encoder generates a slice header comprising information indicating motion vector prediction is possible between the base layer image and the enhancement layer image.

15. A computer-readable recording medium having recorded thereon a program for executing the inter-layer video decoding method of claim 1.

16. A computer-readable recording medium having recorded thereon a program for executing the inter-layer video decoding method of claim 9.
